(19) United States
(12) Patent Application Publication
(10) Pub. No.: US 2026/0367320 A1
(43) Pub. Date: Nov. 19, 2026

(54) SEMICONDUCTOR PHOTONICS DEVICES AND METHODS OF FORMATION

(71) Applicant: Taiwan Semiconductor Manufacturing Company, Ltd., Hsinchu (TW)

(72) Inventors: Eugene I-Chun CHEN, Zhubei City (TW); Chih-Ming CHEN, Hsinchu City (TW); De-Yang CHIOU, Tainan City (TW); Chia-Shiung TSAI, Hsinchu City (TW); Chih-Tsung SHIH, Hsinchu City (TW); Chia-Hua CHU, Zhubei City (TW); Tzu-Heng WU, Hsinchu City (TW)

(21) Appl. No.: 19/755,010

(22) Filed: Jul. 27, 2026

Related U.S. Application Data
(63) Continuation of application No. 18/748,885, filed on Jun. 20, 2024.

(51) Int. Cl. G02B 6/122; G02B 6/12; G02B 6/132; G02B 6/136

(52) U.S. Cl. CPC G02B 6/1228; G02B 6/132; G02B 6/136; G02B 2006/12169

(57) ABSTRACT

A dielectric waveguide structure of a semiconductor photonics device is formed prior to formation of the semiconductor photonics components of the semiconductor photonics device. This enables high-temperature processing techniques to be used to form the dielectric waveguide structure without concern for potential damage that might otherwise be caused to the semiconductor photonics components if the dielectric waveguide were to be formed above the semiconductor photonics components. The use of the high-temperature processing techniques may enable low optical loss to be achieved for the dielectric waveguide structure in that the high-temperature processing techniques may be used to achieve a low hydrogen concentration in the dielectric waveguide structure. The low hydrogen concentration in the dielectric waveguide structure enables higher performance to be achieved for the dielectric waveguide structure, including greater operating efficiency and increased communication bandwidth.

### RELATED APPLICATION

This application is a division of U.S. patent application Ser. No. 18/748,885, filed Jun. 20, 2024, which is incorporated herein by reference in its entirety.

### BACKGROUND

Photonic integrated circuits (PICs) can include multiple types of waveguides that are configured to perform different functions. Semiconductor waveguides (e.g., silicon (Si) waveguides) are often used in optical modulators because of the capability of modulating refractive indices in semiconductor waveguides by applying electric fields to the semiconductor materials of the semiconductor waveguides. Dielectric waveguides are often used for signal propagation and/or edge coupling because of the lower optical loss and higher thermal stability compared to the semiconductor materials of semiconductor waveguides.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1E are diagrams of an example of a semiconductor photonics device described herein.

FIGS. 2A-2K are diagrams of an example implementation of forming a semiconductor photonics device described herein.

FIGS. 3A-3L are diagrams of an example implementation of forming a semiconductor photonics device described herein.

FIGS. 4A-4C are diagrams of an example of a semiconductor photonics device described herein.

FIGS. 5A and 5B are diagrams of an example of a semiconductor photonics device described herein.

FIGS. 6A-6C are diagrams of an example of a semiconductor photonics device described herein.

FIGS. 7A and 7B are diagrams of an example of a semiconductor photonics device described herein.

FIG. 8 is a diagram of an example of a semiconductor photonics device described herein.

FIGS. 9A and 9B are diagrams of an example of a semiconductor photonics device described herein.

FIGS. 10A and 10B are diagrams of an example of a semiconductor photonics device described herein.

FIG. 11 is a diagram of an example of a semiconductor photonics device described herein.

FIGS. 12A-12E are diagrams of an example implementation of forming a semiconductor photonics device described herein.

FIGS. 13A-13H are diagrams of an example implementation of forming a semiconductor photonics device described herein.

FIG. 14 is a flowchart of an example process associated with forming a semiconductor photonics device described herein.

FIG. 15 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Semiconductor waveguides and other semiconductor photonics components of a semiconductor photonics device may be formed in a top silicon layer of a silicon on insulator (SOI) substrate of the semiconductor photonics device. Layers and structures that are formed after formation of the semiconductor photonics components may be limited in the types of processing techniques and/or processing parameters that may be used to form the layers and structures. For example, the components formed in the top silicon layer may have limits for the temperatures to which the components may be exposed, which limits the types of semiconductor processing techniques and/or processing parameters that may be used to form a dielectric edge coupler waveguide above the top silicon layer. Exposing the semiconductor photonics components formed in the top silicon layer to temperatures that are too high may damage and/or degrade the performance of these components. In particular, active components such as optical modulator structures and/or photodetectors may be formed in the top silicon layer, and these active components may be connected to backend interconnects such that power and/or signaling may be provided to these active components. Silicide layers for the contacts of the active components may be susceptible to material migration and/or damage at high temperatures, thereby limiting the formation of the dielectric edge coupler waveguide to low-temperature processing techniques.

The dielectric material of the dielectric edge coupler waveguide may have increased susceptibility to hydrogen absorption and retention at lower processing temperatures, resulting in increased hydrogen concentration in the dielectric edge coupler waveguide. The hydrogen absorbed in the dielectric edge coupler waveguide may cause optical absorption in the dielectric edge coupler waveguide, and therefore the increased hydrogen concentration in the dielectric edge coupler waveguide may result in increased optical loss in the dielectric edge coupler waveguide. Thus, the low-temperature processing techniques may result in lower performance (e.g., lower efficiency and reduced optical communication bandwidth) for the dielectric edge coupler waveguide than if high-temperature processing techniques where used.

In some implementations described herein, a dielectric waveguide structure (e.g., a dielectric edge coupler waveguide) of a semiconductor photonics device is formed prior to formation of the semiconductor photonics components (e.g., semiconductor waveguide structures, optical modulator structures, photodetectors) of the semiconductor photonics device. This enables high-temperature processing techniques (e.g., high-temperature deposition techniques, annealing techniques) to be used to form the dielectric waveguide structure without concern for potential damage and/or degraded performance that might otherwise be caused to the semiconductor photonics components if the dielectric waveguide were formed above the semiconductor photonics components. The use of the high-temperature processing techniques may enable low optical loss to be achieved for the dielectric waveguide structure in that the high-temperature processing techniques may be used to achieve a low hydrogen concentration in the dielectric waveguide structure with minimal to no impact on the optical coupling performance between the dielectric waveguide structure and the semiconductor photonics components. The low hydrogen concentration in the dielectric waveguide structure enables higher performance to be achieved for the dielectric waveguide structure, including greater operating efficiency and increased communication bandwidth. Moreover, the high-temperature planar processing techniques may enable the dielectric waveguide structure to be formed to have greater surface uniformity and smoothness than if low-temperature processing techniques were used, resulting in higher quality interfaces between the dielectric waveguide structure and the surrounding dielectric layers, thereby enabling increased optical confinement (and reduced optical loss) to be achieved in the dielectric waveguide structure.

The dielectric waveguide structure may be formed from a dielectric layer that is formed prior to layer transfer of a top semiconductor layer in which the semiconductor photonics components are formed. The dielectric layer may be a buried nitride layer in a pre-manufactured SOI substrate, where the buried nitride layer is sandwiched between a bottom oxide layer and a top oxide layer under the top semiconductor layer and above a semiconductor substrate layer. The top semiconductor layer, the top oxide layer, and the buried nitride layer may be patterned and etched such that the dielectric waveguide structure can be formed under the top semiconductor layer prior to formation of the semiconductor photonics components in the top semiconductor layer. Alternatively, the bottom oxide layer/buried nitride layer/top oxide layer stack may be formed on the semiconductor substrate layer, and the buried nitride layer may be patterned and etched to form the dielectric waveguide structure prior to the top semiconductor layer being formed or provided. Thus, the use of the buried nitride layer for formation of the dielectric waveguide structure provides increased manufacturing flexibility for forming the semiconductor photonics device, and also enables more types of semiconductor photonics components and greater flexibility for the parameters and attributes for those semiconductor photonics components to be realized.

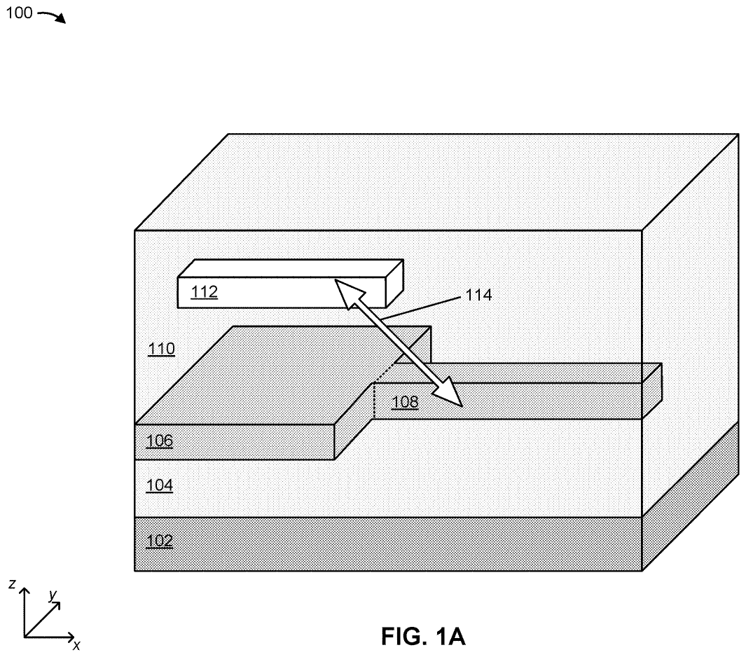

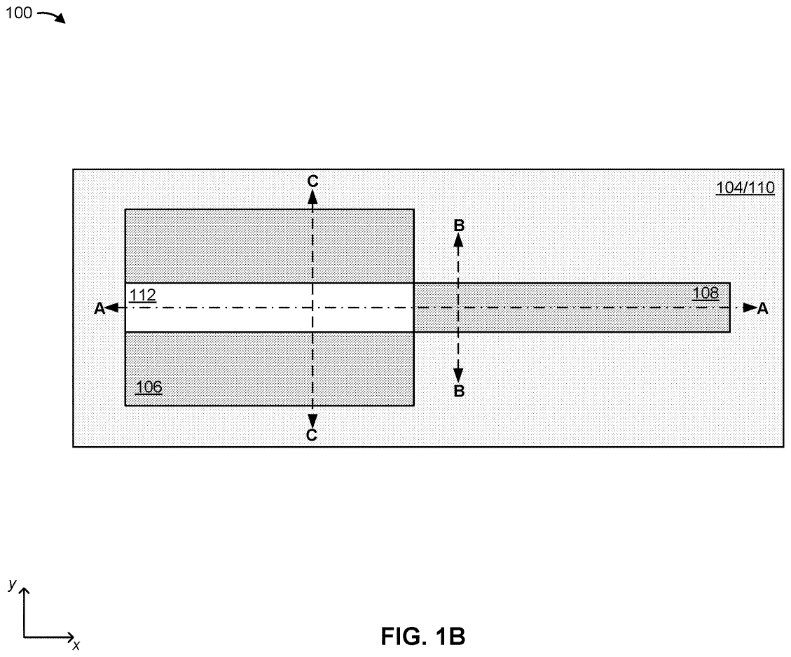

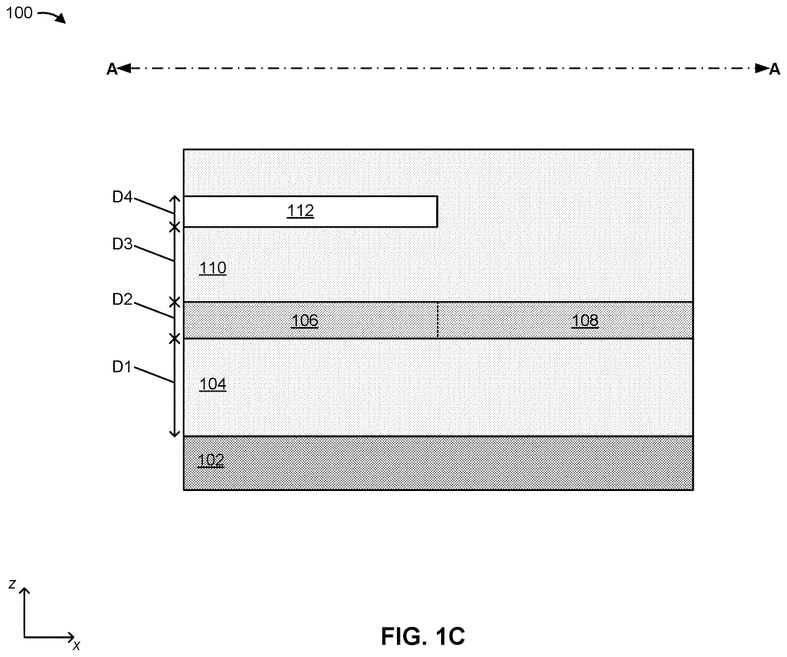

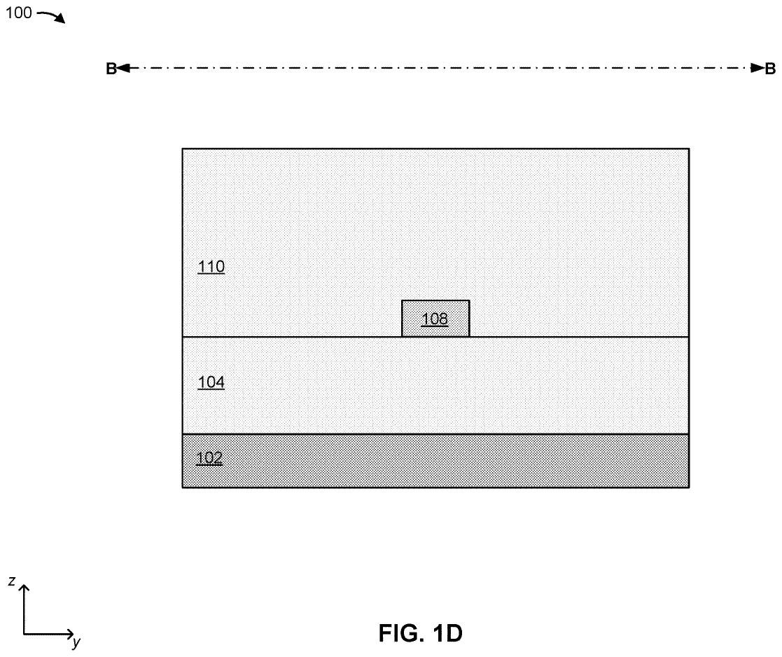

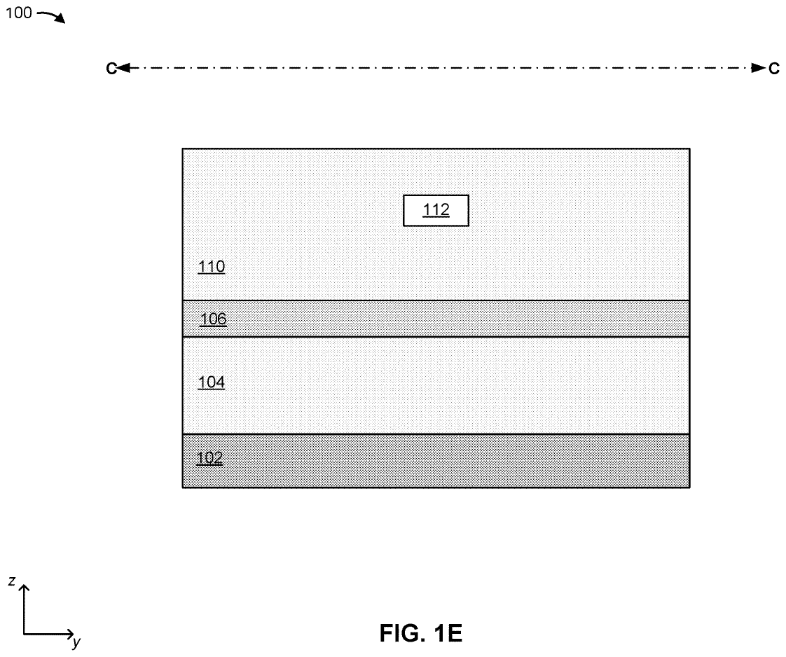

FIGS. 1A-1E are diagrams of an example of a semiconductor photonics device 100 described herein. The semiconductor photonics device 100 may include a photonic integrated circuit that includes a plurality of optical components, such as a dielectric waveguide structure and a semiconductor waveguide structure. The dielectric waveguide structure and the semiconductor waveguide structure are optically coupled to facilitate the transfer of optical signals between the dielectric waveguide structure and the semiconductor waveguide structure. Moreover, the dielectric waveguide structure and the semiconductor waveguide structure are formed using processing techniques described herein such that the dielectric waveguide structure is below the semiconductor waveguide structure. This enables the dielectric waveguide structure to be formed prior to the semiconductor waveguide structure and other semiconductor photonics components of the photonic integrated circuit, which provides greater processing flexibility when forming the dielectric waveguide structure and enables high-temperature processing techniques to be used to form the dielectric waveguide structure.

FIG. 1A illustrates a perspective view of the semiconductor photonics device 100. As shown in FIG. 1A, the semiconductor photonics device 100 may include a semiconductor substrate 102 (e.g., a silicon (Si) substrate and/or another type of semiconductor substrate), a dielectric layer 104 over and/or on the semiconductor substrate 102, and dielectric layer 106 above the dielectric layer 104. The dielectric layer 104 may include a silicon oxide layer (SiOₓ such as SiO₂), an undoped silicate glass (USG) layer, and/or another type of oxide dielectric layer. The dielectric layer 106 may include a nitride dielectric layer that includes a nitride dielectric material having a refractive index greater than the refractive index of silicon dioxide, such as silicon nitride (SiₓN_{y} such as Si₃N₄). Additionally and/or alternatively, the dielectric layer 106 may include another type of dielectric material, such as an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), lithium niobate (LiNbO3), and/or other examples.

In some implementations, one or more additional dielectric layers, such as one or more silicon oxynitride (SiON) transition layers, are included between the dielectric layer 104 and the dielectric layer 106. Additionally and/or alternatively, an alternating superlattice stack of silicon oxide layers and silicon nitride layers may be included between the dielectric layer 104 and the dielectric layer 106 (e.g., to form a reflector structure).

A dielectric waveguide structure 108 is formed from the dielectric layer 106. In some implementations, the dielectric waveguide structure 108 is an edge coupler waveguide that is configured to receive optical signals from and/or provide optical signals to an optical fiber, a fiber optic cable, and/or another type of external optical connection. Additionally and/or alternatively, the dielectric waveguide structure 108 may be configured as another type of dielectric waveguide structure.

The dielectric waveguide structure 108 may include an elongated structure that extends in an x-direction in the semiconductor photonics device 100. Optical signals may propagate through the dielectric waveguide structure 108, for example, in primarily the x-direction, as shown in FIG. 1A. However, the optical signals may propagate through the dielectric waveguide structure 108 in other directions, such as the y-direction, the z-direction, and/or a combination of directions. One or more portions of the dielectric layer 106 may be etched and removed to define the dielectric waveguide structure 108 so as to enable optical signals to be confined in the elongated structure of the dielectric waveguide structure 108. The shape of the dielectric waveguide structure 108 may include a strip waveguide structure, a rib waveguide structure, a deep rib waveguide structure, and/or another type of waveguide structure.

Another dielectric layer 110 may be included above the dielectric layer 106 and around the dielectric waveguide structure 108. A portion of the dielectric layer 110 may include another BOX layer, a silicon oxide layer (SiOₓ such as SiO₂), a USG layer, and/or another type of oxide dielectric layer. The dielectric layers 104 and 110 surrounding the dielectric waveguide structure 108 may function as cladding for the dielectric waveguide structure 108. Thus, the dielectric waveguide structure 108 and the dielectric layers 104 and 110 surrounding the dielectric waveguide structure 108 may correspond to a slab waveguide in which the dielectric waveguide structure 108 includes a high dielectric constant (high-k) or a high refractive index material core that is sandwiched by the low dielectric constant (low-k) or a low refractive index material cladding layers of the dielectric layers 104 and 110. The difference in dielectric constants of the high-k material of the dielectric waveguide structure 108 and the low-k material of the dielectric layers 104 and 110 may enable loose coupling of optical signal modes in the dielectric waveguide structure 108 while providing a relatively low critical angle for achieving total internal reflections in the dielectric waveguide structure 108. This enables the dielectric waveguide structure 108 to be used with high-frequency optical signals for high-speed and/or high-bandwidth applications, such as data center communications, millimeter wave telecommunications (e.g., fifth generation (5G) telecommunications, sixth generation (6G) telecommunications, or a later generation of telecommunications), autonomous driving, Internet of Things (IoT), and/or artificial intelligence, among other examples.

As further shown in FIG. 1A, a semiconductor waveguide structure 112 may be included in the dielectric layer 110. The semiconductor waveguide structure 112 may be located above the dielectric layer 106. Moreover, the semiconductor waveguide structure 112 may be located above the dielectric waveguide structure 108 (e.g., at a higher z-direction position in the semiconductor photonics device 100 than the dielectric waveguide structure 108) and may at least partially laterally offset from the dielectric waveguide structure 108 in the x-direction. The semiconductor waveguide structure 112 may be physically separated from the dielectric layer 106 and the dielectric waveguide structure 108 by the dielectric layer 110, which provides optical isolation for the semiconductor waveguide structure 112 while still permitting coupling of optical signals 114 between the semiconductor waveguide structure 112 and the dielectric waveguide structure 108 at the end of the semiconductor waveguide structure 112 facing the dielectric waveguide structure 108.

The semiconductor waveguide structure 112 may include one or more semiconductor materials, such as silicon (Si), silicon doped with one or more types of dopants (e.g., p-type dopants, n-type dopants), germanium (Ge), silicon germanium (SiGe), a III-V semiconductor material (e.g., a semiconductor material that includes one or more group III elements of the periodic table and one or more group V elements of the periodic table), and/or another suitable semiconductor material. The semiconductor waveguide structure 112 may include an elongated structure that extends in the x-direction in the semiconductor photonics device 100. Optical signals may propagate through the semiconductor waveguide structure 112 primarily in the x-direction. The semiconductor waveguide structure 112 may be formed from a semiconductor layer that is etched to define the semiconductor waveguide structure 112. In the example illustrated in FIG. 1A, the semiconductor waveguide structure 112 has a strip waveguide structural shape. However, the semiconductor waveguide structure 112 may conform to other structural shapes, such as a rib waveguide structural shape and/or a tapered waveguide structural shape, among other examples.

FIG. 1B illustrates a top view of the semiconductor photonics device 100. As shown in FIG. 1B, the y-direction lateral width of the dielectric waveguide structure 108 is less than the y-direction lateral width of the dielectric layer 106. This enables optical signals to be confined in a smaller area within the dielectric waveguide structure 108 for low optical signal loss and increased operating efficiency. The semiconductor waveguide structure 112 may be located over the dielectric layer 106, and the dielectric layer 106 may extend laterally outward (e.g., in the y-direction) past the edges of the semiconductor waveguide structure 112.

FIG. 1C illustrates a cross-sectional view of the semiconductor photonics device 100 along the line A-A in the x-direction in FIG. 1B. Thus, the location of the cross-section view of the semiconductor photonics device 100 in FIG. 1C is along the dielectric waveguide structure 108 and along the semiconductor waveguide structure 112. As shown in FIG. 1C, the end of the semiconductor waveguide structure 112 facing the dielectric waveguide structure 108 may be approximately located above a transition between the dielectric layer 106 and the dielectric waveguide structure 108. Alternatively, the semiconductor waveguide structure 112 may at least partially extend over the dielectric waveguide structure 108 such that the semiconductor waveguide structure 112 at least partially overlaps in the x-direction with the dielectric waveguide structure 108.

As further shown in FIG. 1C, the dielectric layer 104 may have a dimension D1 corresponding to a z-direction thickness of the dielectric layer 104. In some implementations, the z-direction thickness of the dielectric layer 104 is greater than approximately 2 microns and less than approximately 3 microns to provide sufficient optical isolation between the dielectric waveguide structure 108 and the semiconductor substrate 102. However, other values and ranges for the z-direction thickness of the dielectric layer 104 are within the scope of the present disclosure.

The dielectric layer 106 may have a dimension D2 corresponding to a z-direction thickness of the dielectric layer 106. In some implementations, the z-direction thickness of the dielectric layer 106 is included in a range of approximately 150 nanometers to approximately 500 nanometers to achieve sufficient confinement and low loss for optical signals in the dielectric waveguide structure 108, depending on the wavelengths of the optical signals and/or other parameters of the dielectric waveguide structure 108 such as material and refractive index. However, other values and ranges for the z-direction thickness of the dielectric layer 106 are within the scope of the present disclosure.

The dielectric layer 110 may have a dimension D3 corresponding to a z-direction thickness of a portion of the dielectric layer 110. In some implementations, the z-direction thickness of the portion of dielectric layer 110 is included in a range of approximately 150 nanometers to approximately 300 nanometers to achieve sufficient optical isolation between the dielectric layer 106 and the semiconductor waveguide structure 112 while enabling optical coupling to occur between the dielectric waveguide structure 108 and the semiconductor waveguide structure 112. However, other values and ranges for the z-direction thickness of the portion of the dielectric layer 110 are within the scope of the present disclosure.

The semiconductor waveguide structure 112 may have a dimension D4 corresponding to a z-direction thickness of the semiconductor waveguide structure 112. In some implementations, the z-direction thickness of the semiconductor waveguide structure 112 is included in a range of approximately 150 nanometers to approximately 500 nanometers to achieve sufficient confinement and low loss for optical signals in the semiconductor waveguide structure 112, depending on the wavelengths of the optical signals and/or other parameters of the semiconductor waveguide structure 112 such as material and refractive index. However, other values and ranges for the z-direction thickness of the semiconductor waveguide structure 112 are within the scope of the present disclosure.

FIG. 1D illustrates a cross-section view of the semiconductor photonics device 100 along the line B-B in the y-direction in FIG. 1B. Thus, the location of the cross-section view of the semiconductor photonics device 100 in FIG. 1D is across the dielectric waveguide structure 108 at a location along the dielectric waveguide structure 108 wherein the semiconductor waveguide structure 112 is not directly over and above the dielectric waveguide structure 108. As shown in FIG. 1D, the dielectric waveguide structure 108 may have a strip waveguide cross-sectional profile in the y-direction. Moreover, the dielectric waveguide structure 108 may be surrounded by the dielectric layers 104 and 110.

FIG. 1E illustrates a cross-section view of the semiconductor photonics device 100 along the line C-C in the y-direction in FIG. 1B. Thus, the location of the cross-section view of the semiconductor photonics device 100 in FIG. 1E is across the dielectric layer 106 and the semiconductor waveguide structure 112 above the dielectric layer 106. As shown in FIG. 1E, the semiconductor waveguide structure 112 may be located above the dielectric layer 106, and may be physically separated from the dielectric layer 106 by the dielectric layer 110. The semiconductor waveguide structure 112 may have a strip waveguide cross-sectional profile in the y-direction. Moreover, the semiconductor waveguide structure 112 may be surrounded by the dielectric layer 110.

As indicated above, FIGS. 1A-1E are provided as an example. Other examples may differ from what is described with regard to FIGS. 1A-1E.

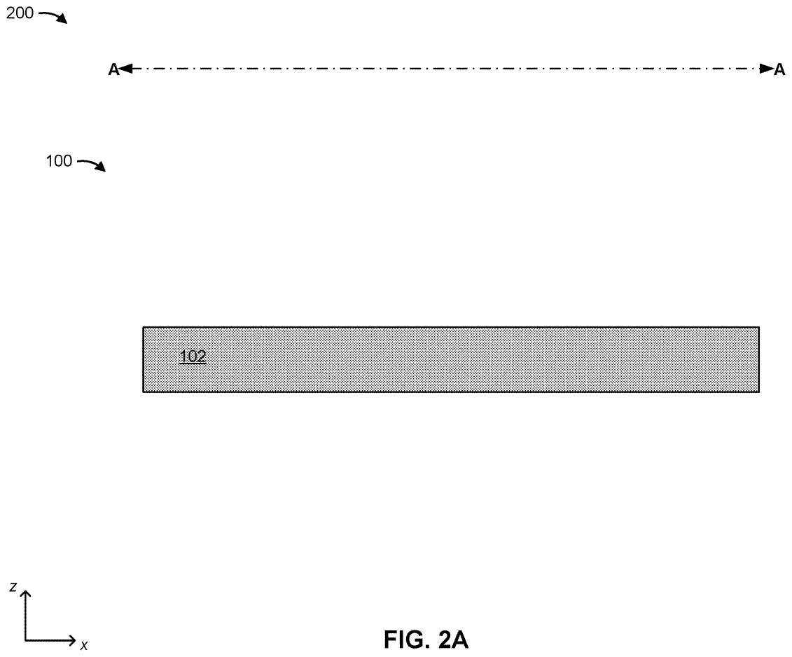

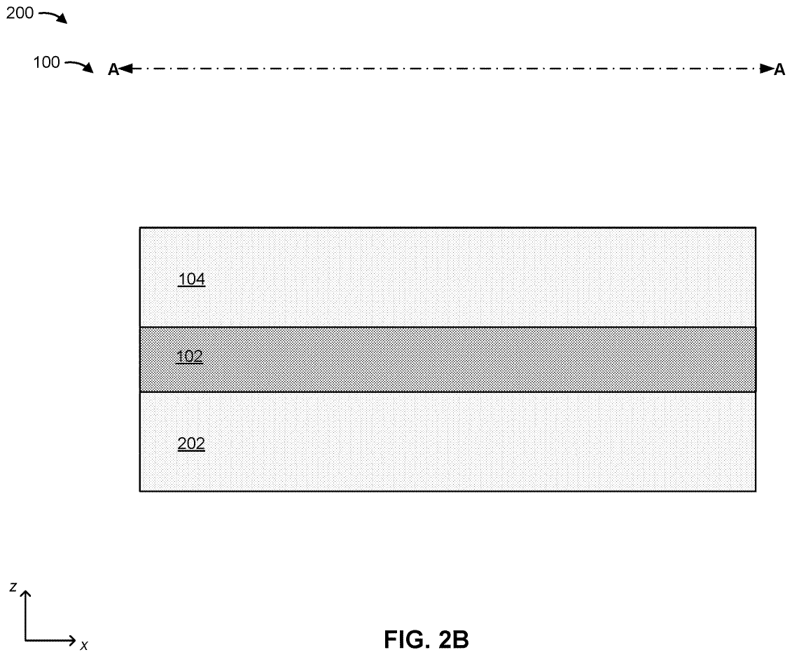

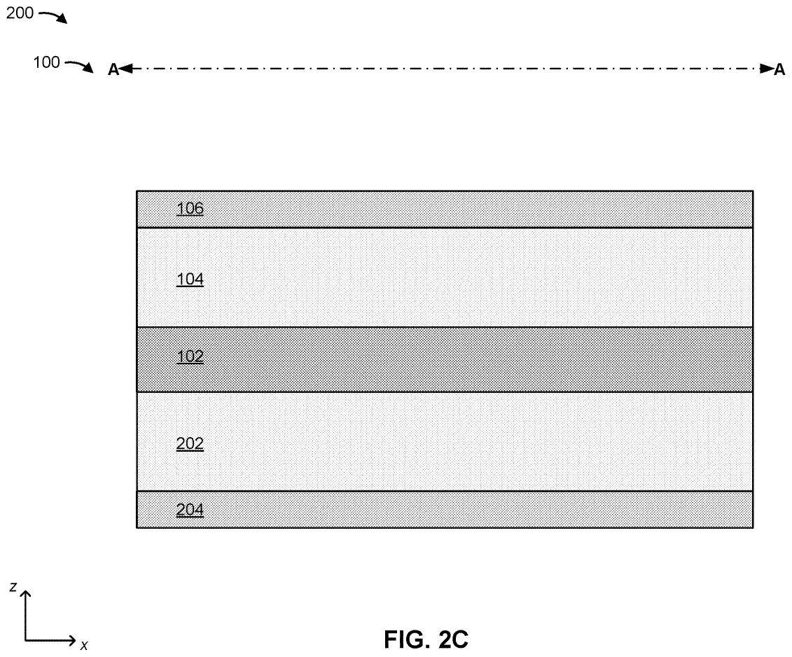

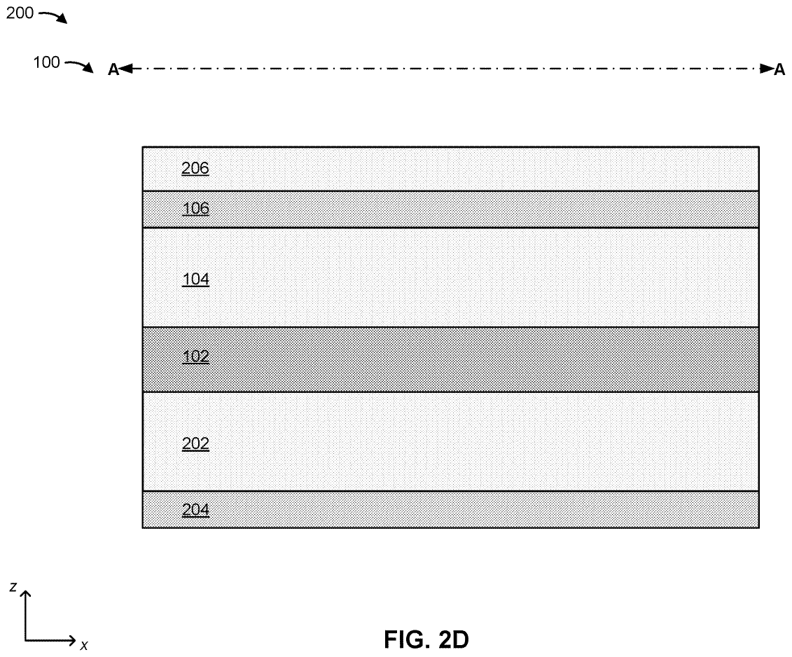

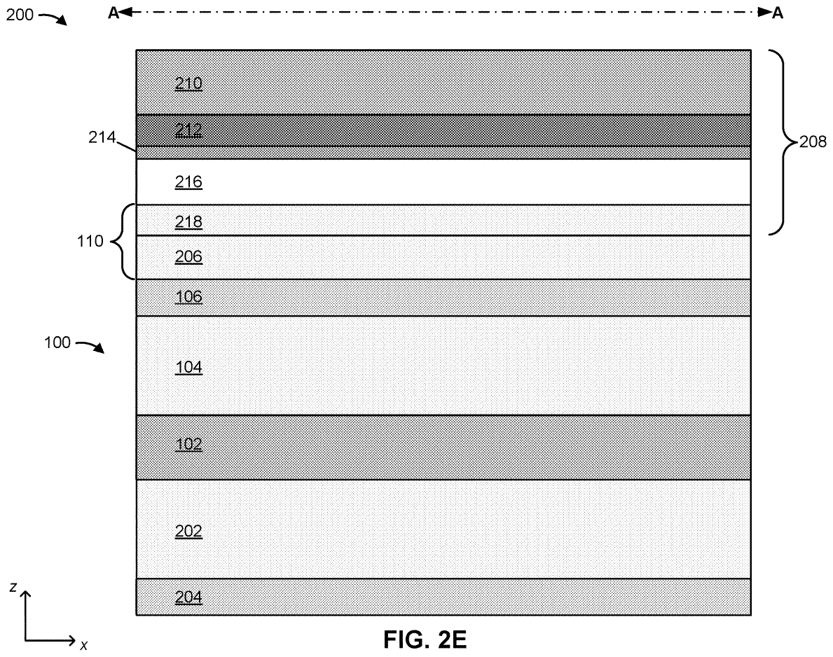

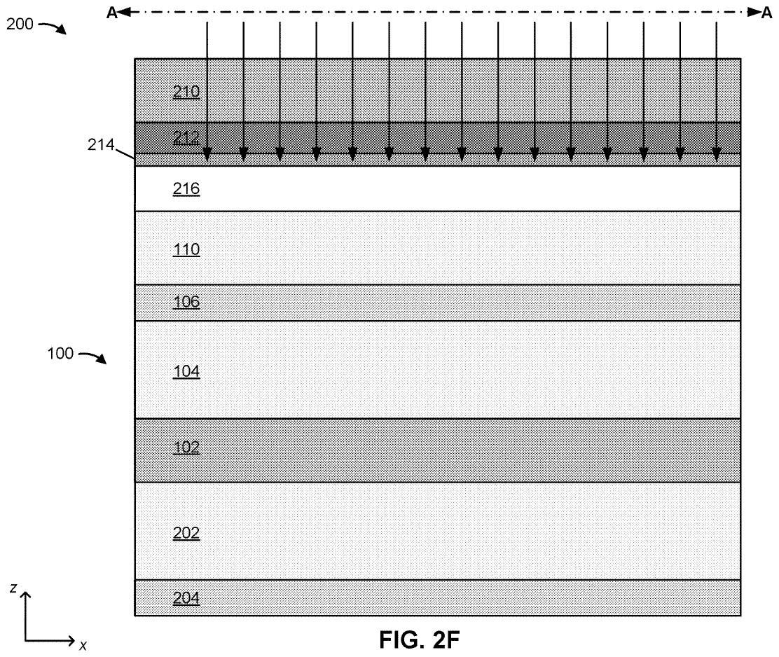

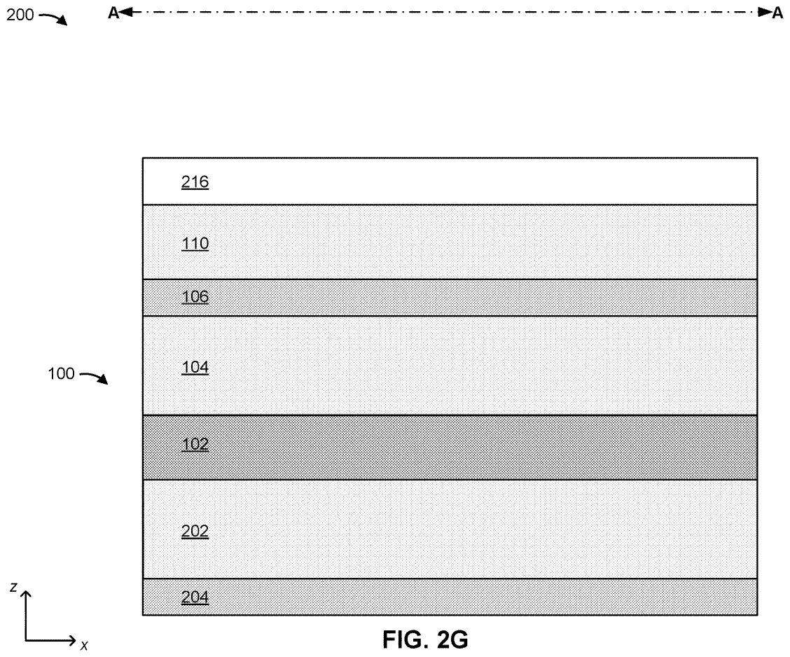

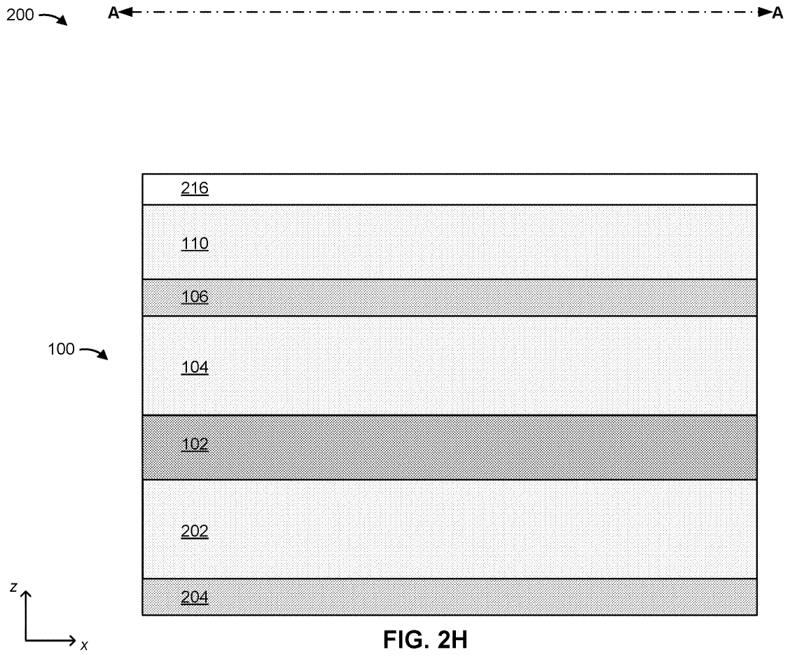

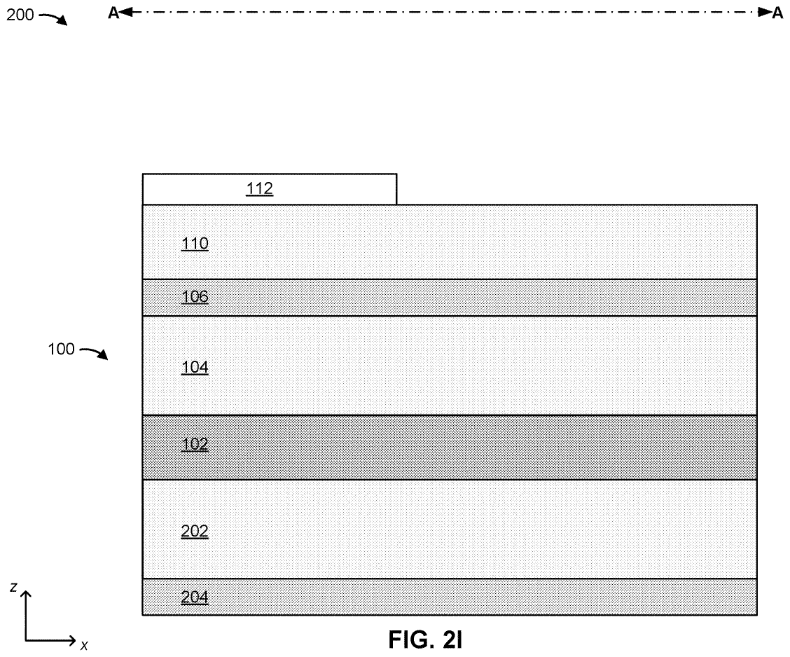

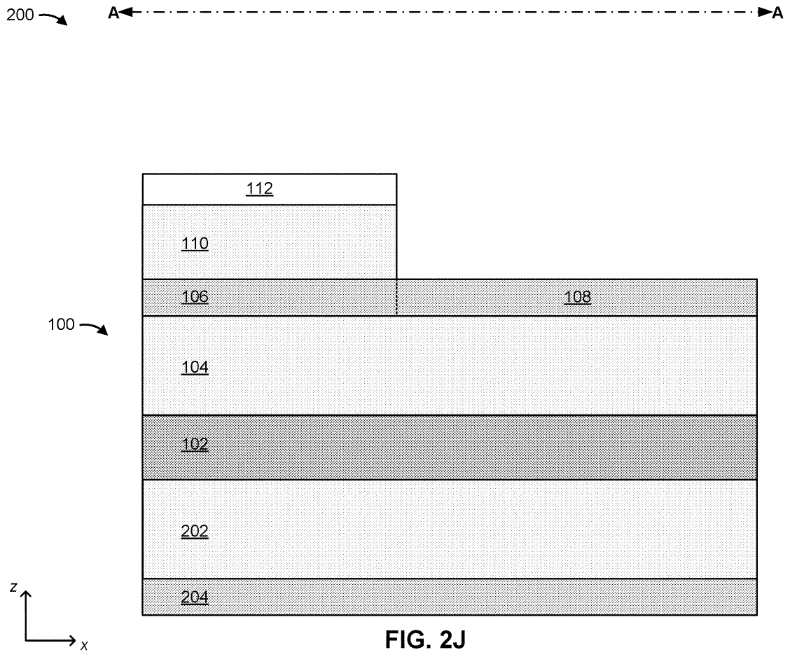

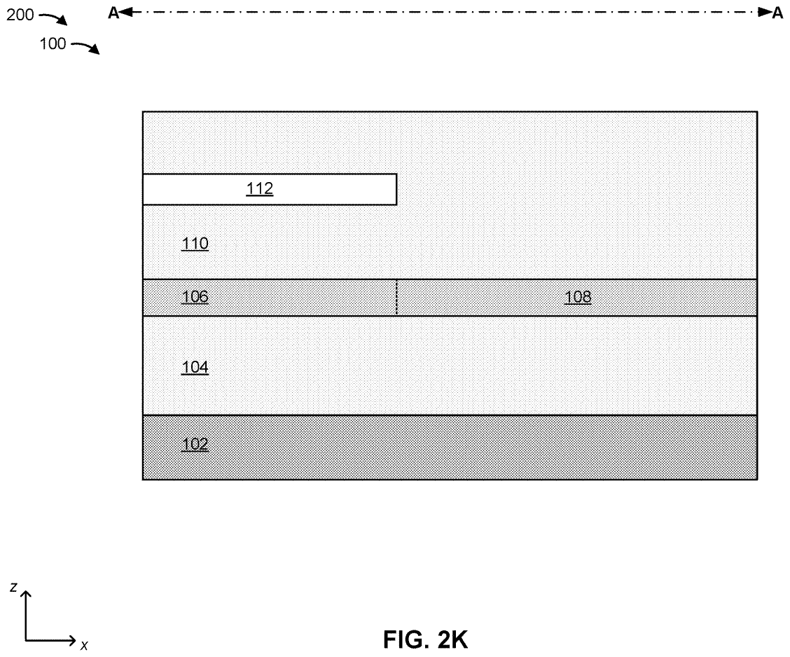

FIGS. 2A-2K are diagrams of an example implementation 200 of forming the semiconductor photonics device 100 described herein. In particular, the example implementation 200 includes an example of forming the dielectric waveguide structure 108 of the semiconductor photonics device 100 prior to formation of the semiconductor photonics components of the semiconductor photonics device 100 such as the semiconductor waveguide structure 112. The semiconductor photonics components such as the semiconductor waveguide structure 112 are formed above the dielectric waveguide structure 108 in the semiconductor photonics device 100. The example implementation 200 includes an example of patterning the dielectric layer 106 and forming the dielectric waveguide structure 108 from the dielectric layer 106 after forming or providing a top semiconductor layer from which the semiconductor photonics components such as the semiconductor waveguide structure 112 are formed.

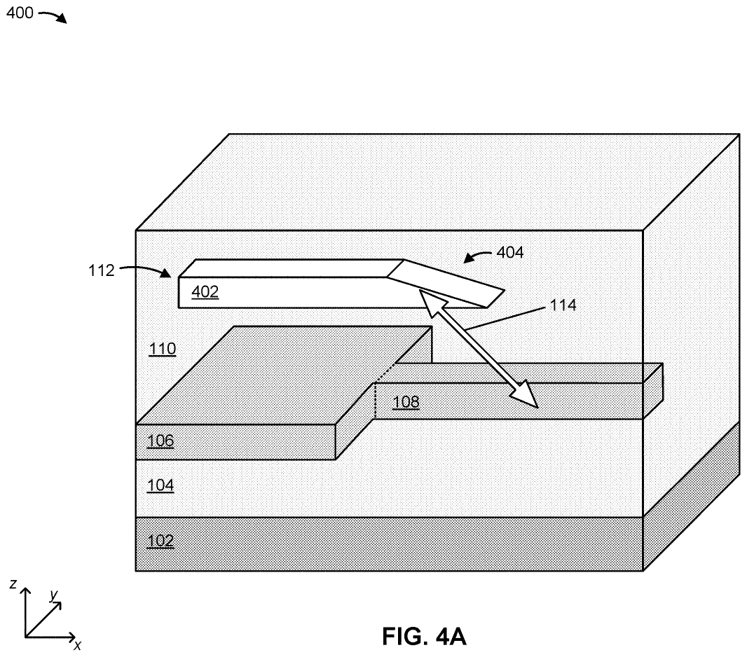

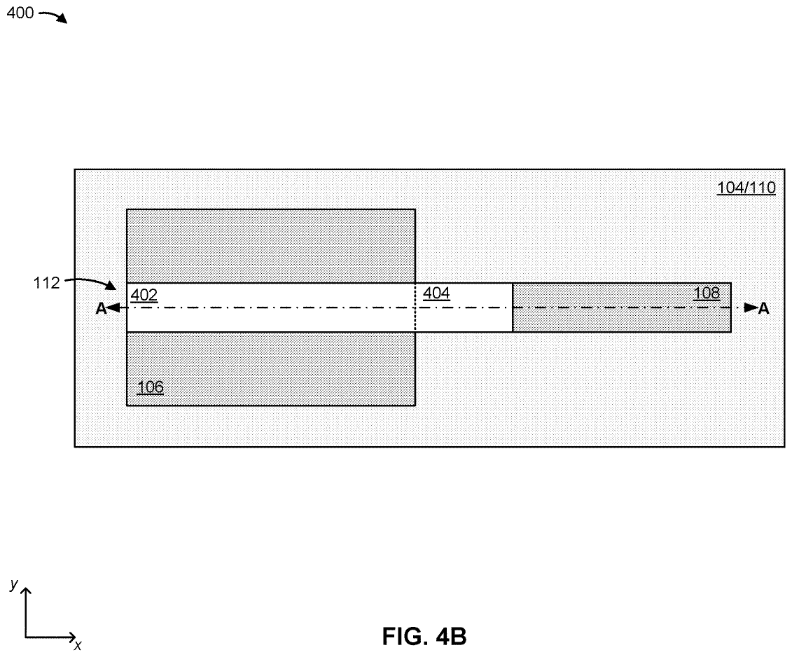

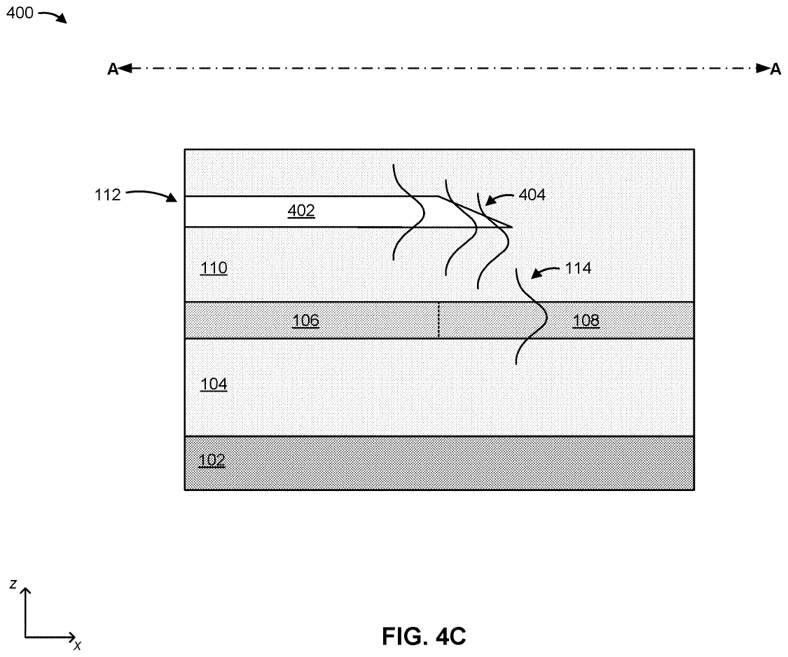

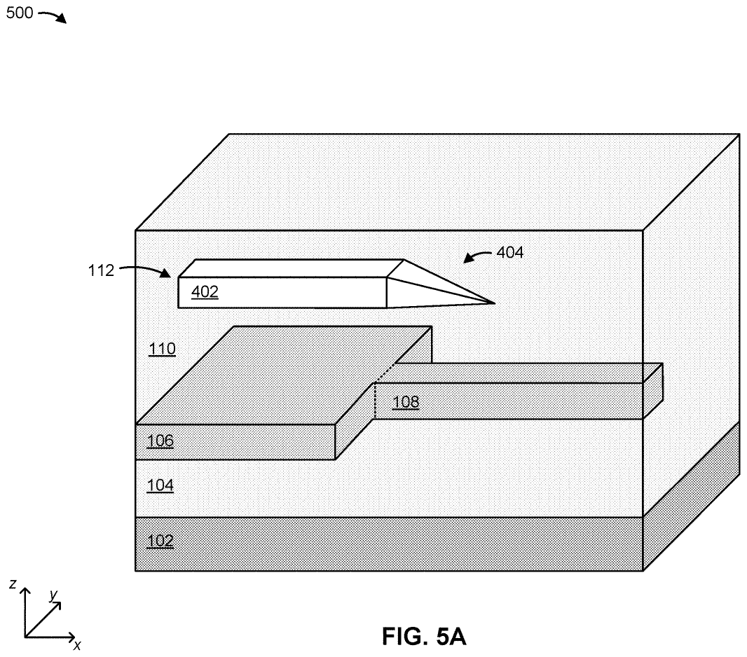

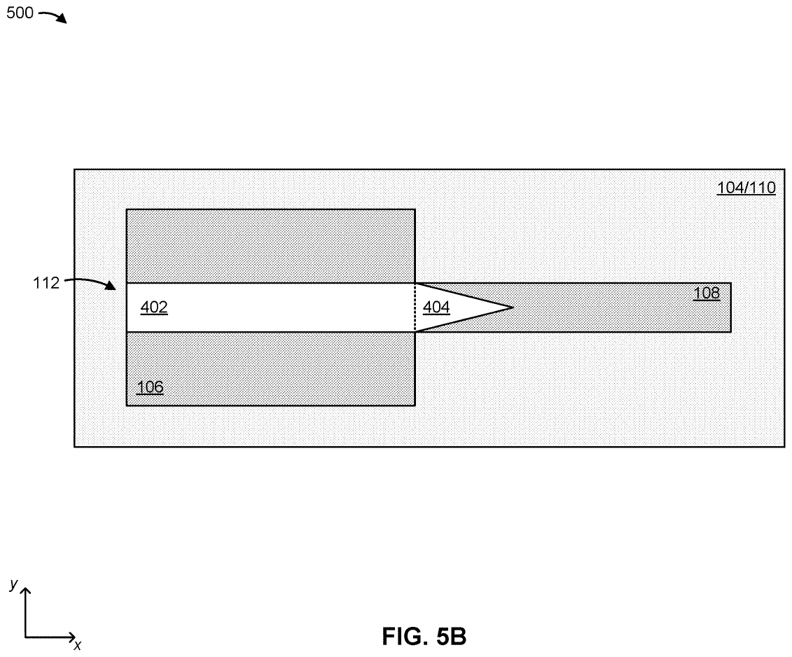

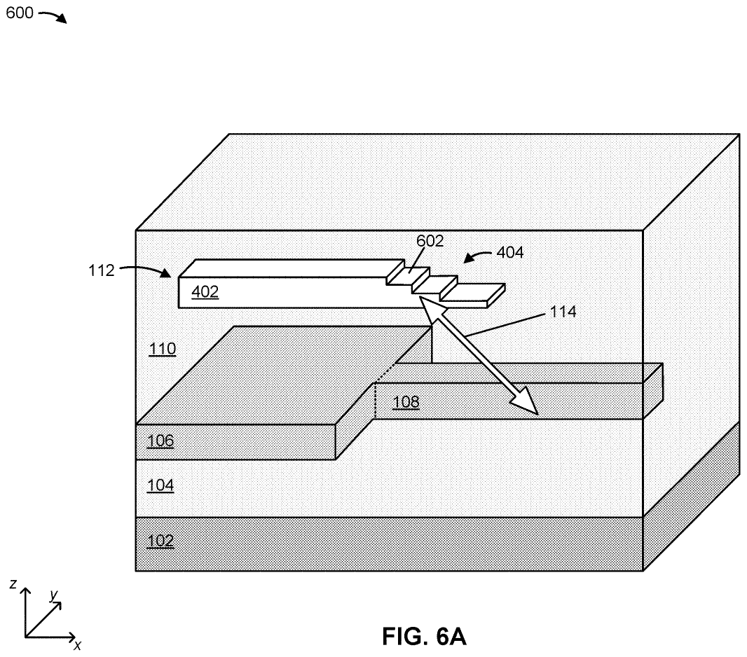

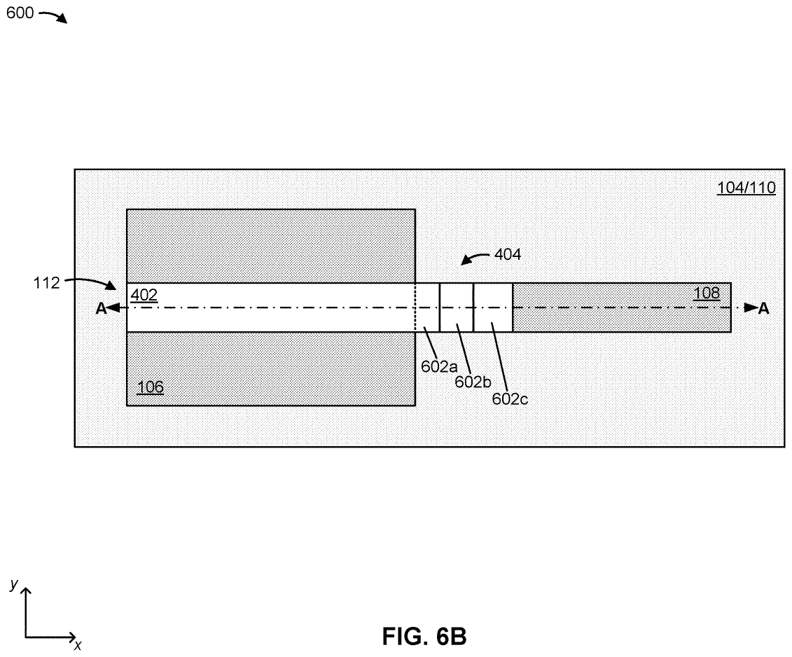

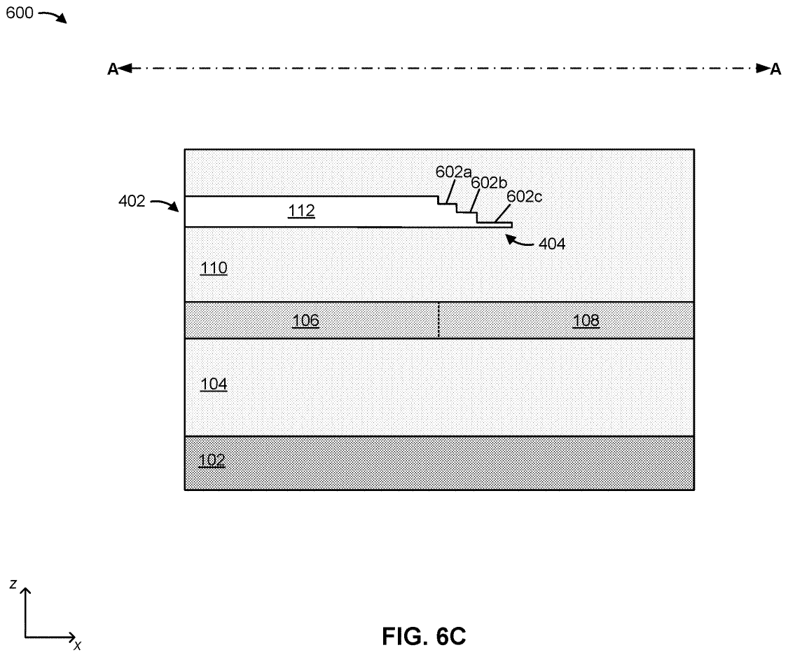

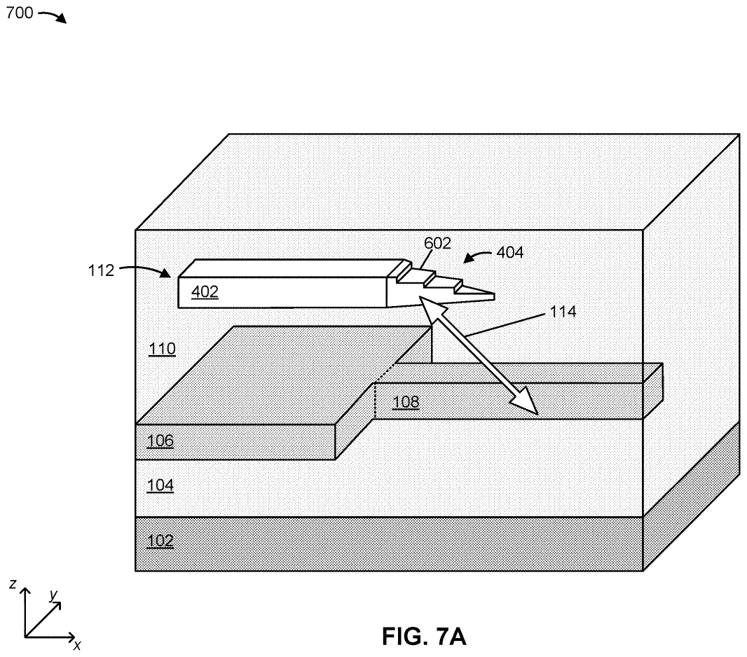

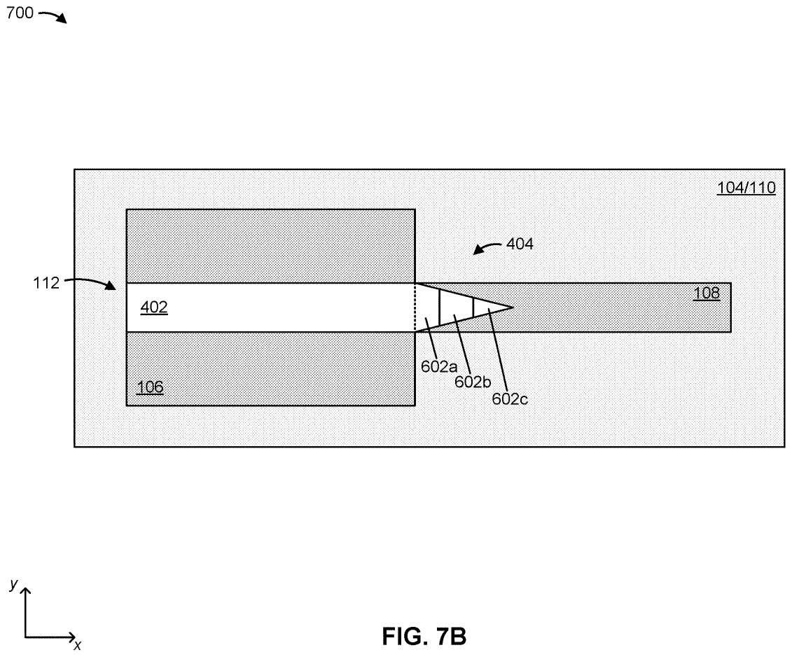

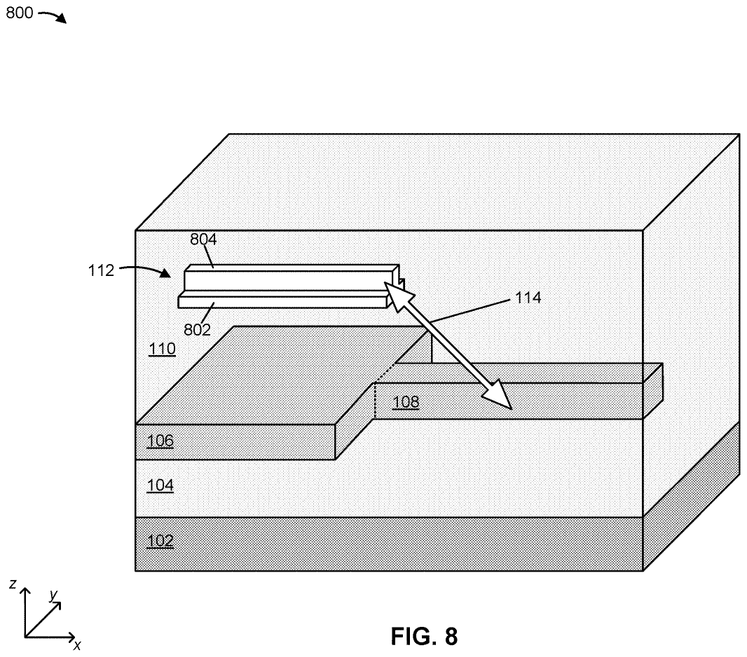

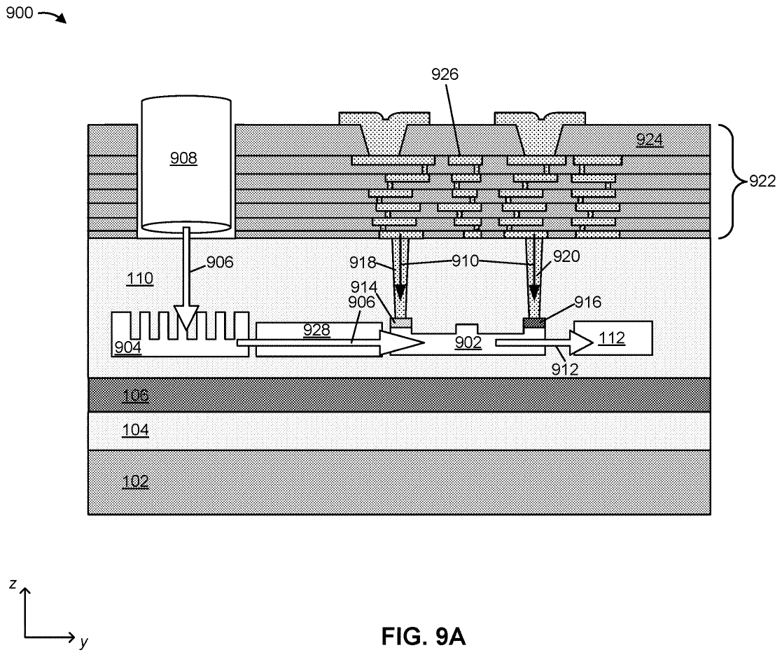

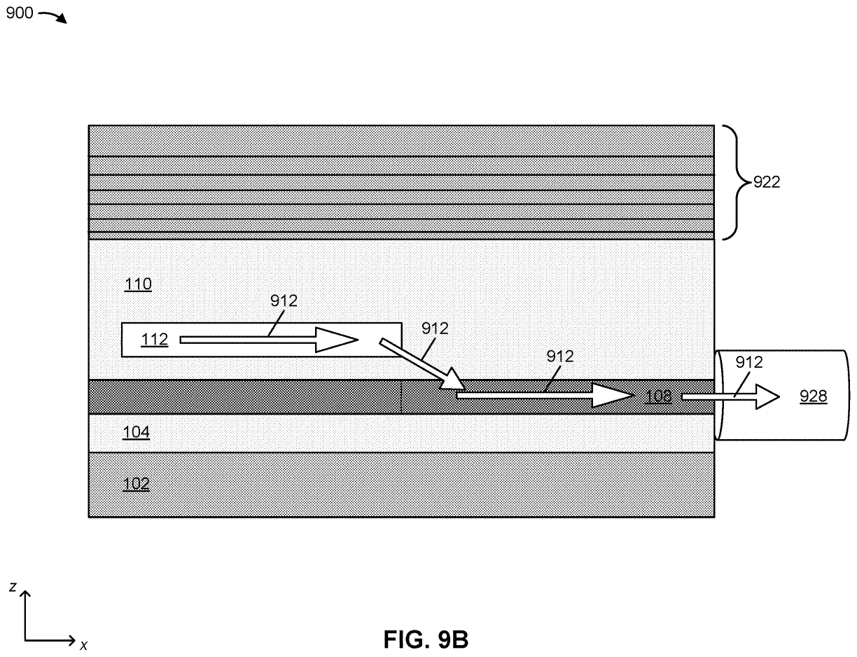

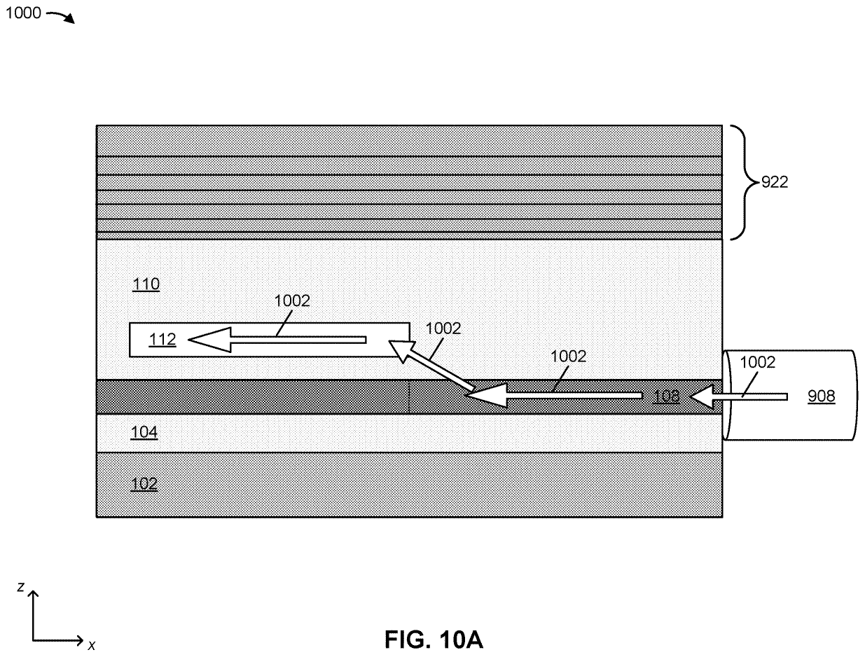

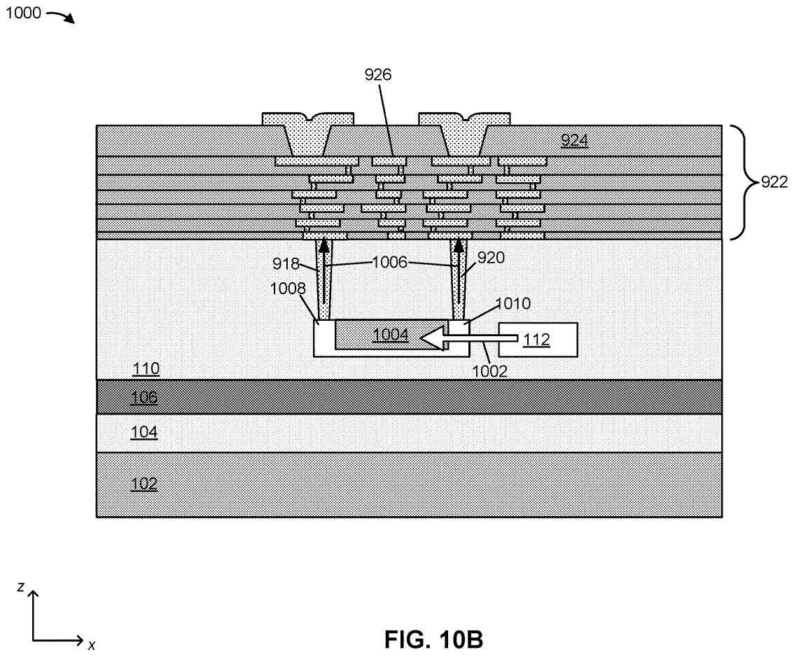

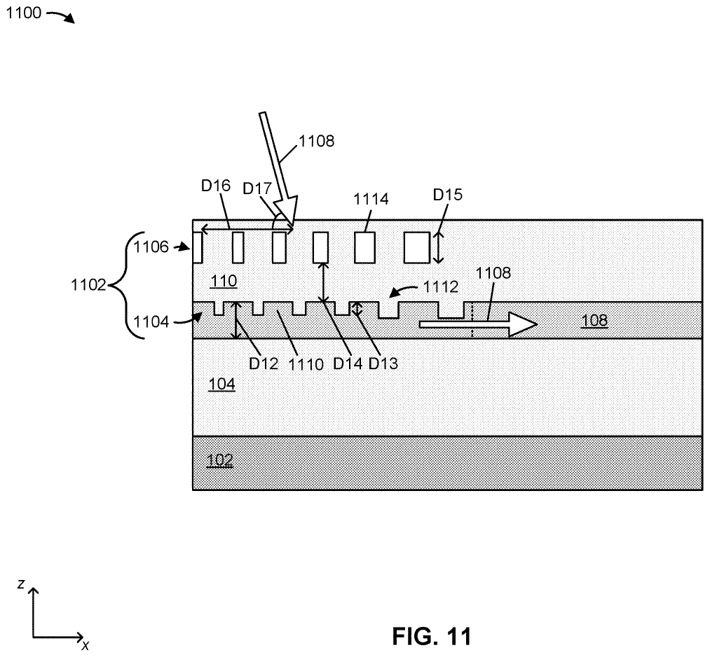

In some implementations, one or more operations described in connection with FIGS. 2A-2K are performed using a semiconductor processing tool, such as a deposition tool, an exposure tool, a developer tool, an etch tool, a planarization tool, a bonding tool, and/or an annealing tool, among other examples. In some implementations, one or more operations described in connection with FIGS. 2A-2K may be performed to form another semiconductor photonics device described herein, such as a semiconductor photonics device 400 illustrated and described in connection with FIGS. 4A-4C, a semiconductor photonics device 500 illustrated and described in connection with FIGS. 5A and 5B, a semiconductor photonics device 600 illustrated and described in connection with FIGS. 6A-6C, a semiconductor photonics device 700 illustrated and described in connection with FIGS. 7A and 7B, a semiconductor photonics device 800 illustrated and described in connection with FIG. 8, a semiconductor photonics device 900 illustrated and described in connection with FIGS. 9A and 9B, a semiconductor photonics device 1000 illustrated and described in connection with FIGS. 10A and 10B, and/or a semiconductor photonics device 1100 illustrated and described in connection with FIG. 11, among other examples.

Turning to FIG. 2A, one or more of the operations in the example implementation 200 may be performed in connection with the semiconductor substrate 102. The semiconductor substrate 102 may be provided in the form of a semiconductor wafer or another type of semiconductor substrate.

As shown in FIG. 2B, the dielectric layer 104 may be formed on the semiconductor substrate 102. In some implementations, the dielectric layer 104 is formed in multiple steps. A deposition tool may be used to form a first portion of the dielectric layer 104 using a thermal oxidation technique. Additionally and/or alternatively, a deposition tool may be used to form the first portion of the dielectric layer 104 using a physical vapor deposition (PVD) technique, a chemical vapor deposition (CVD) technique, and/or another suitable deposition technique. In some implementations, a planarization tool is used to perform a chemical mechanical planarization (CMP) operation or another type of planarization operation on the first portion of the dielectric layer 104. In some implementations, the dielectric layer 104 may be formed to a thickness that is included in a range of approximately 2 microns to approximately 2.3 microns. However, other values and ranges for the thickness of the dielectric layer 104 are within the scope of the present disclosure. In some implementations, a buffer layer 202 is formed on the backside of the semiconductor substrate 102 in a similar manner.

A deposition tool may be used to form a second portion of the dielectric layer 104 on the first portion using a high-density plasma (HDP) CVD technique, a low-pressure CVD (LPCVD) technique and/or another deposition technique. For example, a tetraethyl orthosilicate (TEOS) LPCVD technique may be used to form the second portion of the dielectric layer 104, which may include the use of TEOS (Si(OC₂H₅)₄) as a precursor for forming the oxide dielectric material of the second portion of the dielectric layer 104. As another example, a high-temperature oxide (HTO) LPCVD technique may be used to form the second portion of the dielectric layer 104, which may include the use of a nitrous oxide (N₂O) gas and dichlorosilane (DCS-H₂SiCl₂) as precursors that react to form the oxide dielectric material of the second portion of the dielectric layer 104. In some implementations, an annealing tool is used to perform an annealing operation on the dielectric layer 104 after the second portion is formed to diffuse the first portion and the second portion and/or to drive out hydrogen from the dielectric layer 104.

In some implementations, the z-direction thickness of the dielectric layer 104 is greater than approximately 2 microns and less than approximately 3 microns after the second portion of the dielectric layer 104 is formed. However, other values and ranges are within the scope of the present disclosure. The first portion of the dielectric layer 104 (e.g., that is formed by thermal oxidation) may have a greater z-direction thickness than the z-direction thickness of the second portion of the dielectric layer 104 (e.g., that is formed by deposition such as CVD). In some implementations, a ratio of the z-direction thickness of the first portion of the dielectric layer 104 to the z-direction thickness of the second portion of the dielectric layer 104 may be included in a range of approximately 4:1 to approximately 24:1. However, other values and ranges are within the scope of the present disclosure.

As shown in FIG. 2C, the dielectric layer 106 is formed on the dielectric layer 104. The dielectric layer 106 may be formed using high-temperature processing techniques to ensure that the dielectric layer 106 is formed to have little to no hydrogen content. In some implementations, another buffer layer 204 is formed on the backside of the semiconductor substrate 102 in a similar manner.

As an example, a deposition tool may be used to deposit the dielectric layer 106 using an LPCVD technique (with or without a post-annealing operation) such that the dielectric layer 106 is deposited at a temperature that is included in a range of approximately 700 degrees Celsius to approximately 900 degrees Celsius. In some implementations, the dielectric layer 106 is deposited at a temperature that is greater than 900 degrees Celsius.

As another example, a deposition tool may be used to deposit the dielectric layer 106 using a plasma-enhanced CVD (PECVD) technique, and an annealing tool may be used to perform an annealing operation on the dielectric layer 106 after (or while) the dielectric layer 106 is deposited. In some implementations, the annealing operation includes a rapid thermal annealing (RTA) operation that is performed at a temperature that is greater than or approximately equal to 800 degrees Celsius. In some implementations, the annealing operation includes a furnace annealing operation that is performed at a temperature that is greater than or approximately equal to 1150 degrees Celsius.

Using the high-temperature LPCVD technique (with or without a post-annealing operation) or the PECVD technique with the post-annealing operation enables high temperatures to be used to break the hydrogen bonds (—H bonds) in the dielectric layer 106. This drives out hydrogen from the dielectric layer 106, thereby reducing the hydrogen content and concentration in the dielectric layer 106. For example, if the dielectric layer 106 includes a silicon nitride (SiₓN_{y} such as Si₃N₄) layer, the high temperature of the high-temperature LPCVD technique or the PECVD technique with the post-annealing operation breaks the silicon-hydrogen (Si-H) bonds and/or the nitrogen-hydrogen (N-H) bonds in the dielectric layer 106, thereby reducing the hydrogen content and concentration in the dielectric layer 106. Since the PECVD technique may be performed at lower temperatures than the high-temperature LPCVD technique (e.g., in a temperature range of approximately 200 degrees Celsius to approximately 500 degrees Celsius), the concentration of silicon-hydrogen bonds in the dielectric layer 106 (e.g., the silicon nitride layer) after the post-annealing operation is less than the concentration of silicon-hydrogen bonds in the dielectric layer 106 silicon nitride layer prior to the post-annealing operation. Similarly, the concentration of nitrogen-hydrogen bonds in the dielectric layer 106 (e.g., the silicon nitride layer) after the post-annealing operation is less than a concentration of nitrogen-hydrogen bonds in the dielectric layer 106 (e.g., the silicon nitride layer) prior to the post-annealing operation.

In some implementations, a planarization tool is used to perform a CMP operation or another type of planarization operation on the dielectric layer 106. In some implementations, the dielectric layer 106 is formed to a z-direction thickness that is included in a range of approximately 150 nanometers to approximately 500 nanometers. However, other values and ranges are within the scope of the present disclosure.

As shown in FIG. 2D, a dielectric layer 206 is formed on the dielectric layer 106. The dielectric layer 206 may correspond to a first portion of the dielectric layer 110. The dielectric layer 206 may be formed in a similar manner as described above for the dielectric layer 106 to achieve a low hydrogen concentration in the dielectric layer 206. For example, a high-temperature LPCVD technique (with or without a post-annealing operation) or a PECVD with a post-annealing operation may be used to form the dielectric layer 206.

In some implementations, a planarization tool is used to perform a CMP operation or another type of planarization operation on the dielectric layer 206. In some implementations, the dielectric layer 206 is formed to a thickness that is included in a range of approximately 100 nanometers to approximately 200 nanometers. However, other values and ranges are within the scope of the present disclosure.

As shown in FIG. 2E, a wafer stack 208 is bonded to the semiconductor photonics device 100. The wafer stack 208 may include a carrier wafer 210, an etch stop layer 212, an etch stop layer 214, a semiconductor layer 216, and a dielectric layer 218. A bonding tool may be used to bond the dielectric layer 218 of the wafer stack 208 with the dielectric layer 206 on the semiconductor photonics device 100. The wafer stack 208 is bonded to the semiconductor photonics device 100 to provide or attach the semiconductor layer 216 onto the semiconductor photonics device 100.

The carrier wafer 210 may include a silicon (Si) wafer or another type of carrier wafer. The etch stop layer 212 may include a silicon (Si) layer. The carrier wafer 210 may be doped with a first dopant type (e.g., p-type dopants) and the etch stop layer 212 may be doped with a second dopant type (e.g., n-type dopants or a p-type dopant of different concentration from layer 212). The etch stop layer 214 may include a semiconductor material such as silicon germanium (SiGe), among other examples. The semiconductor layer 216 may include a semiconductor material such as silicon (Si), silicon doped with one or more types of dopants (e.g., p-type dopants, n-type dopants), germanium (Ge), silicon germanium (SiGe), a III-V semiconductor material (e.g., gallium arsenide (GaAs), gallium nitride (GaN), indium gallium arsenide (InGaAs), indium phosphate (InP)), germanium tin (GeSn), and/or another suitable semiconductor material. The dielectric layer 218 may correspond to a second portion of the dielectric layer 110.

As shown in FIGS. 2F and 2G, the carrier wafer 210 and the etch stop layers 212 and 214 may be removed from the semiconductor photonics device 100 after the wafer stack 208 is bonded to the semiconductor photonics device 100. The remaining layers of the wafer stack 208 include the semiconductor layer 216 and the second portion of the dielectric layer 110.

In some implementations, the carrier wafer 210 and the etch stop layers 212 and 214 are removed by performing a plurality of etch operations. The different materials of the carrier wafer 210 and the etch stop layers 212 and 214 enable each of the carrier wafer 210 and the etch stop layers 212 and 214 to be removed in a respective etch operation because of the etch selectivity provided by the different materials of the carrier wafer 210 and the etch stop layers 212 and 214. For example, an etch tool may be used to perform a first etch operation to remove the carrier wafer 210, an etch tool may be used to perform a second etch operation to remove the etch stop layer 212, and an etch tool may be used to perform a third etch operation to remove the etch stop layer 214, where the third etch operation stops on the semiconductor layer 216.

Additionally and/or alternatively, other techniques may be used to remove the carrier wafer 210, the etch stop layer 212, and/or the etch stop layer 214. For example, a wafer thinning tool (e.g., a wafer grinding tool) may be used to perform a wafer grinding operation to remove the carrier wafer 210. As another example, a planarization tool may be used to perform a CMP operation to remove the etch stop layer 212, and/or the etch stop layer 214. As another example, the etch stop layer 214 may be replaced by a scribe line layer. A laser may be used to weaken the scribe line layer, which enables the carrier wafer 210 and the etch stop layer 212 to be removed through scribing the scribe line layer. Alternatively, an ion implantation tool may be used to implant ions into the scribe line layer to weaken the scribe line layer.

In some implementations, portions of the dielectric layers 104, 106, and/or 110 are formed on a wafer edge (e.g., an edge bevel of the wafer) of a semiconductor wafer (e.g., the semiconductor substrate 102) on which the semiconductor photonics device 100 is formed. Accordingly, the portions of the dielectric layers 104, 106, and/or 110 are formed on a wafer edge that may also be etched and removed. An additional annealing step may be performed for surface smoothing or damage removal.

As shown in FIG. 2H, a planarization tool may be used to perform a CMP operation to planarize the semiconductor layer 216 after the wafer stack 208 is removed. The CMP operation may be performed to flatten the top surface of the semiconductor layer 216, and/or to reduce a thickness of the semiconductor layer 216 to a desired thickness. In some implementations, the z-direction thickness of the semiconductor layer 216 is included in a range of approximately 150 nanometers to approximately 500 nanometers. However, other values and ranges are within the scope of the present disclosure.

In some implementations, the buffer layers 202 and/or 204 may be removed from the semiconductor substrate 102. In some implementations, the buffer layers 202 and/or 204 are retained in the semiconductor photonics device 100. In some implementations, the backside of the semiconductor substrate 102 may be protected such that the buffer layers 202 and/or 204 are not formed on the backside of the semiconductor substrate 102.

As shown in FIG. 2I, the semiconductor layer 216 may be etched to remove portions of the semiconductor layer 216 to form the semiconductor waveguide structure 112 and/or to form other semiconductor photonics components described herein (e.g., an optical modulator structure 902, a grating coupler 904, a photodetector structure 1004) above the dielectric layer 106. In some implementations, a pattern in a photoresist layer is used to etch the semiconductor layer 216 to form the semiconductor waveguide structure 112 and/or to form other semiconductor photonics components described herein. In these implementations, a deposition tool may be used to form the photoresist layer on the semiconductor layer 216. An exposure tool may be used to expose the photoresist layer to a radiation source to pattern the photoresist layer. A developer tool may be used to develop and remove portions of the photoresist layer to expose the pattern.

An etch tool may be used to etch the semiconductor layer 216 based on the pattern to form the semiconductor waveguide structure 112 and/or to form other semiconductor photonics components described herein. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the semiconductor layer 216 based on a pattern. In some implementations, multiple patterning and etching operations are performed to form the semiconductor waveguide structure 112 and/or to form other semiconductor photonics components described herein.

As shown in FIG. 2J, the dielectric layers 106 and 110 may be etched to remove portions of the dielectric layers 106 and 110 to form the dielectric waveguide structure 108 below the semiconductor waveguide structure 112 and/or to form other semiconductor photonics components described herein. In some implementations, a pattern in a photoresist layer is used to etch the dielectric layers 106 and 110 to form the dielectric waveguide structure 108. In these implementations, a deposition tool may be used to form the photoresist layer on the semiconductor layer 216 and on the dielectric layer 110. An exposure tool may be used to expose the photoresist layer to a radiation source to pattern the photoresist layer. A developer tool may be used to develop and remove portions of the photoresist layer to expose the pattern.

An etch tool may be used to etch the dielectric layers 106 and 110 based on the pattern to form the dielectric waveguide structure 108. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layers 106 and 110 based on a pattern.

In some implementations, multiple patterning and etching operations are performed to form the dielectric waveguide structure 108. For example, a first etch operation may be performed to etch the dielectric layer 110, and the first etch operation stops on the dielectric layer 106. A second etch operation may then be performed to etch the dielectric layer 106 to form the dielectric waveguide structure 108.

As shown in FIG. 2K, additional material of the dielectric layer 110 is formed over the dielectric waveguide structure 108 and over the semiconductor waveguide structure 112 to encapsulate the dielectric waveguide structure 108 and the semiconductor waveguide structure 112 in dielectric material. In some implementations, a low-temperature deposition technique (e.g., PECVD) is used to deposit the additional material of the dielectric layer 110 so as to not damage the semiconductor waveguide structure 112 and/or other semiconductor photonics components formed in the semiconductor layer 216. A deposition tool may be used to deposit the additional material of the dielectric layer 110 using a PVD technique, a CVD technique, and/or another suitable deposition technique. In some implementations, a planarization tool may be used to perform a planarization operation (e.g., a CMP operation) to planarize the dielectric layer 110 after the additional material of the dielectric layer 110 is deposited.

As indicated above, FIGS. 2A-2K are provided as an example. Other examples may differ from what is described with regard to FIGS. 2A-2K.

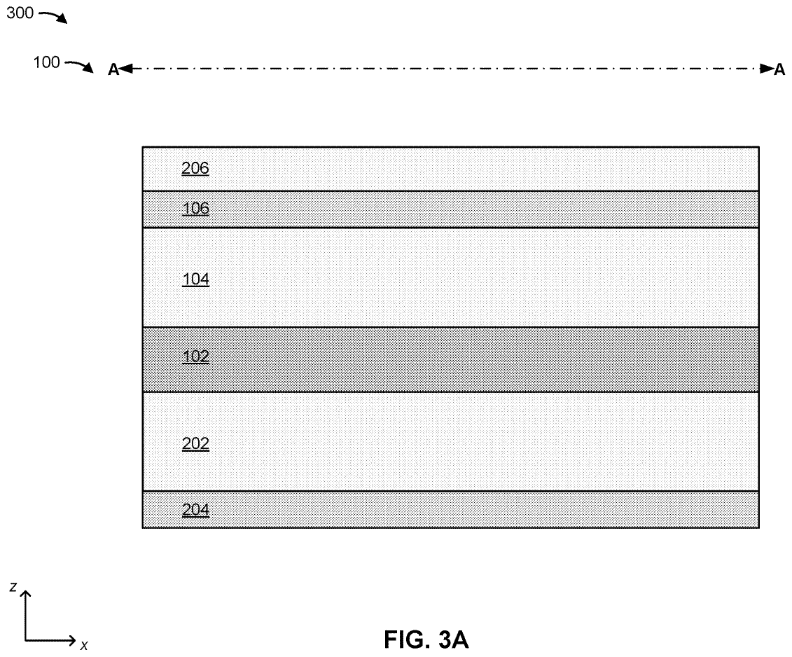

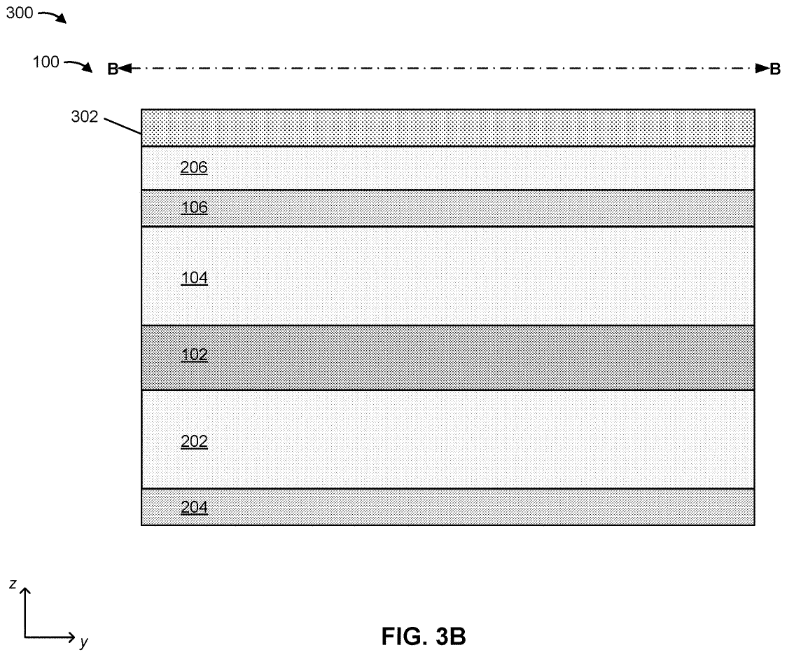

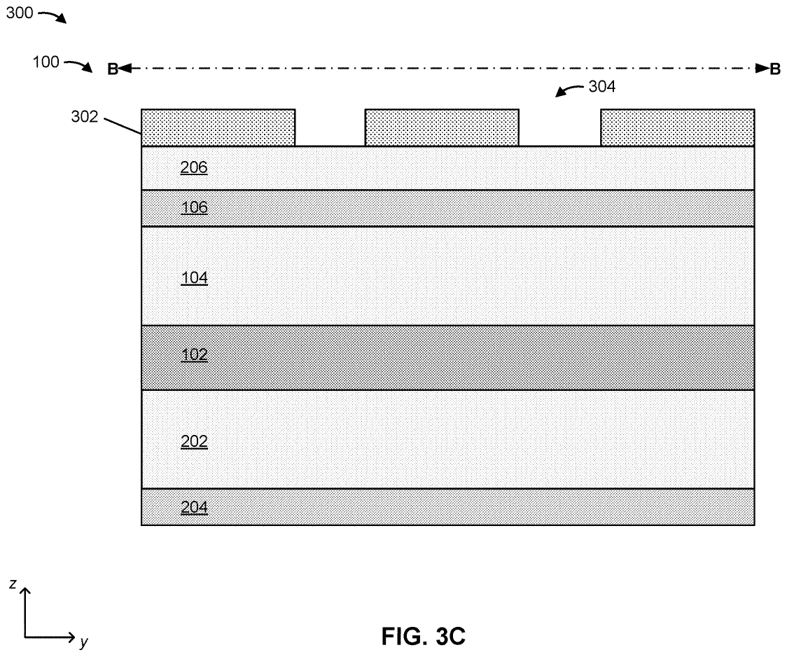

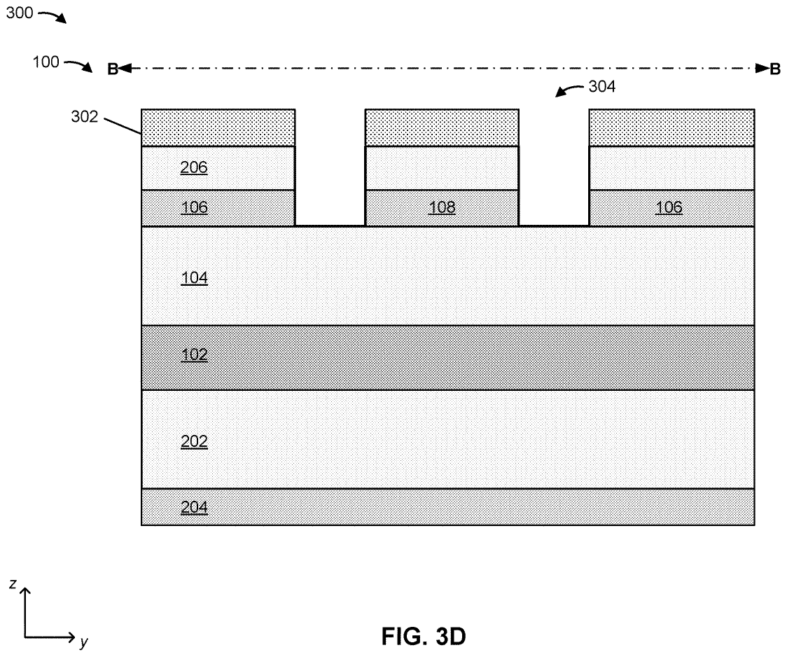

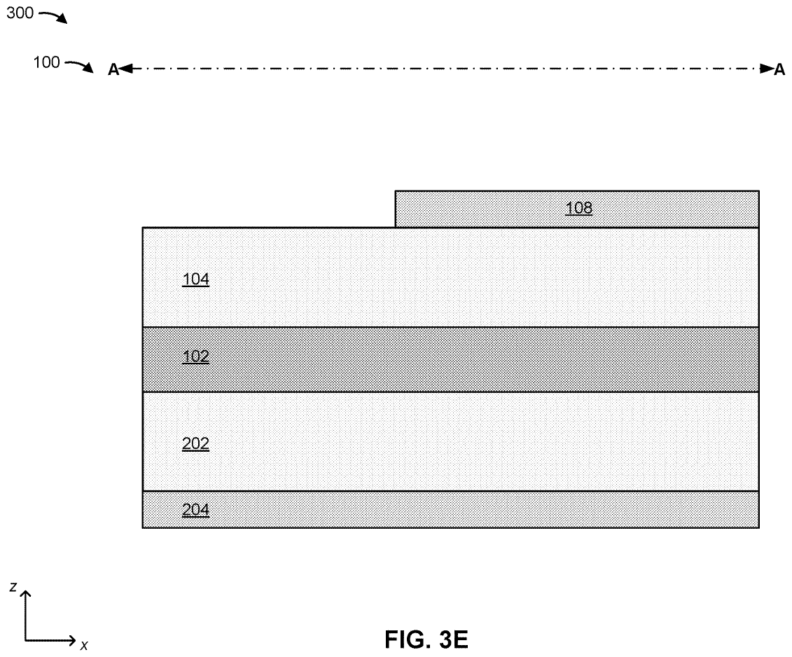

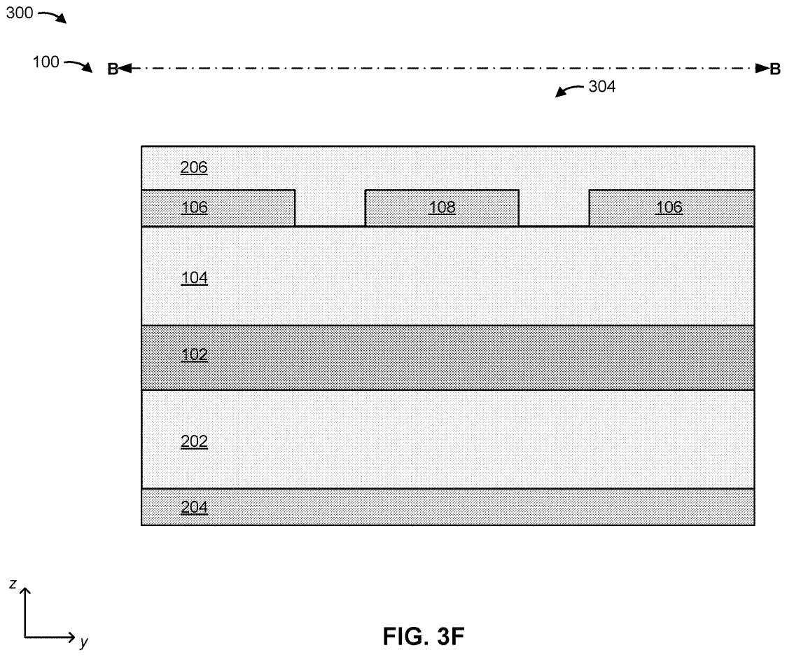

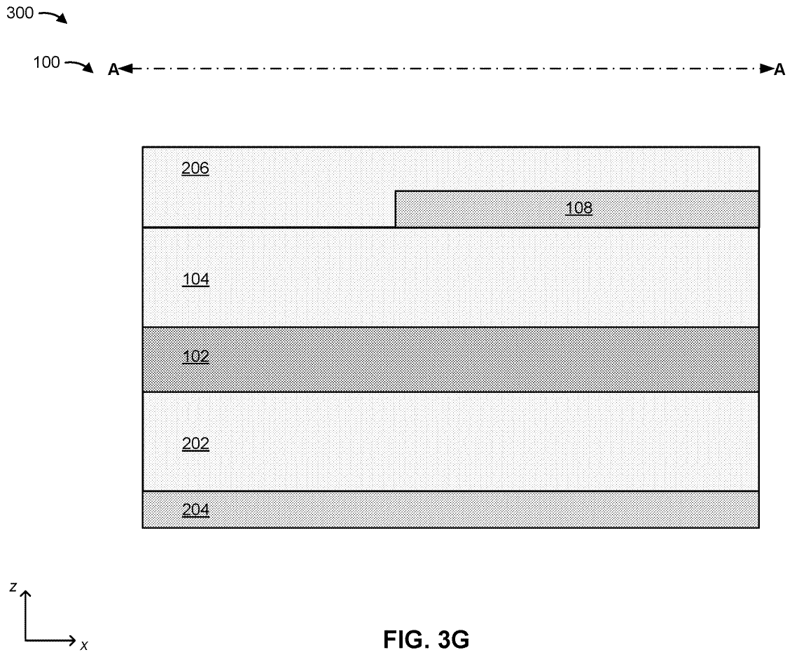

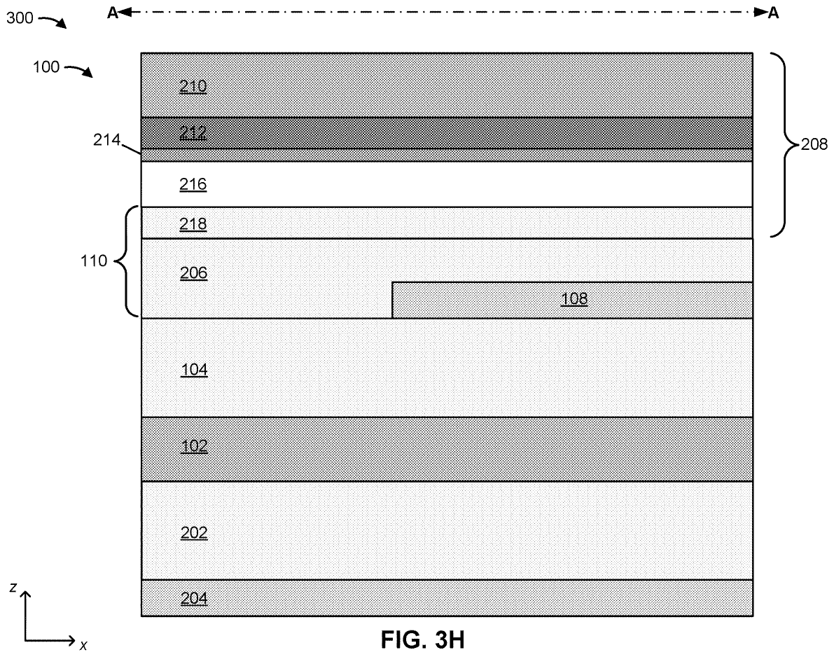

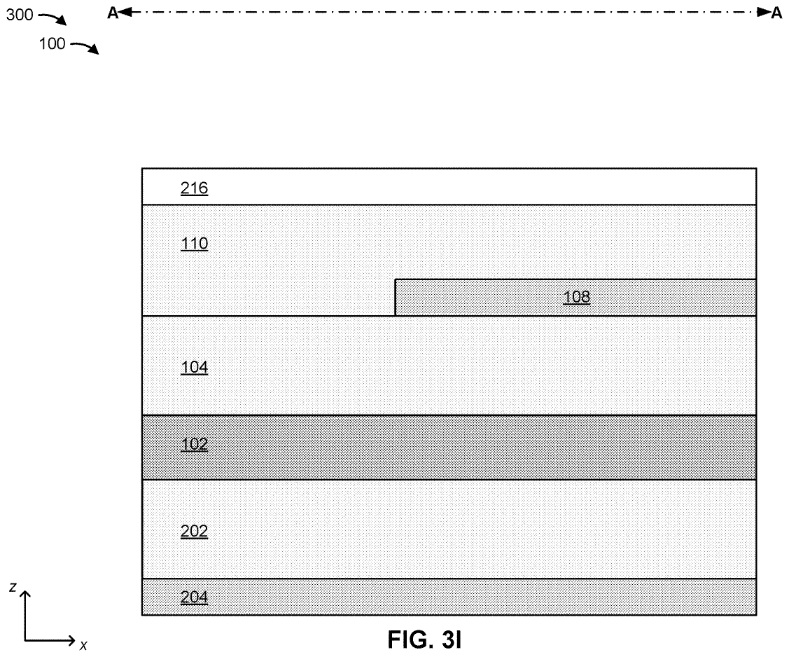

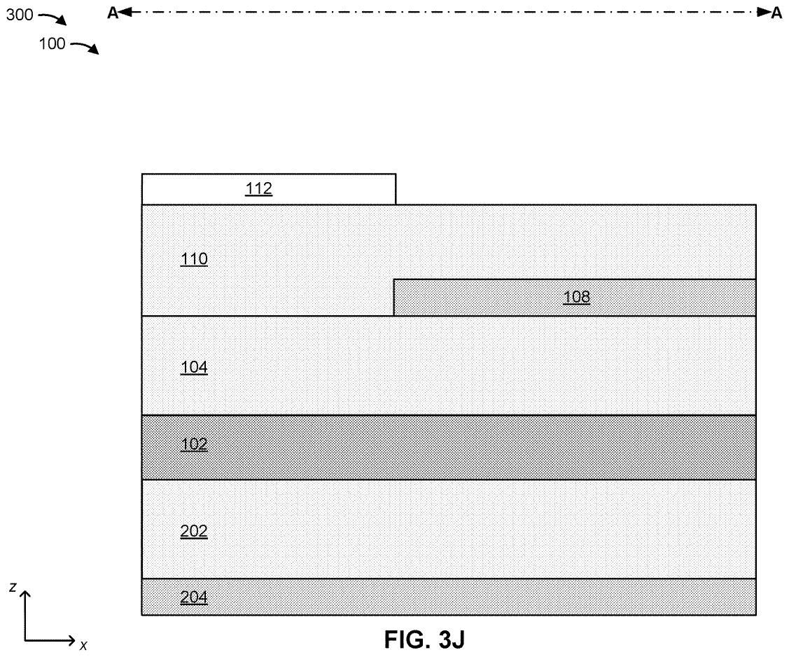

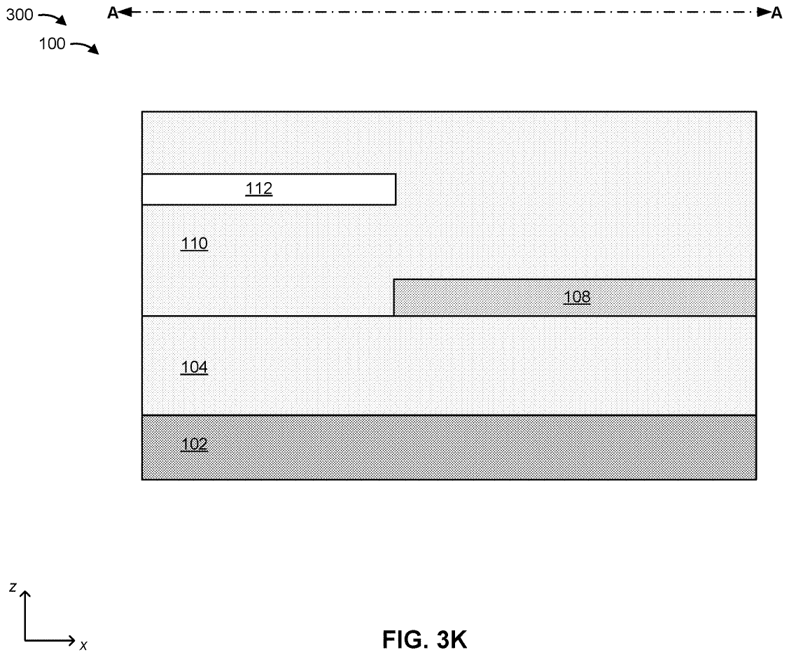

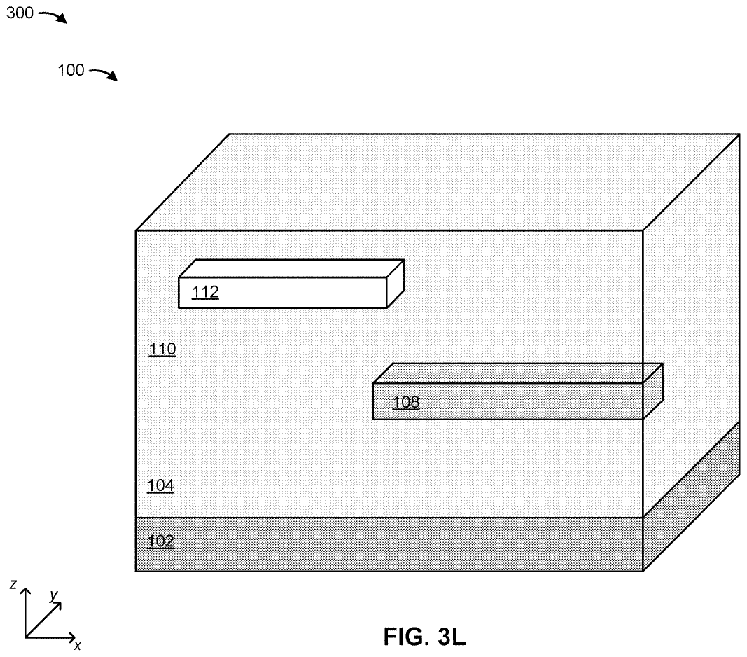

FIGS. 3A-3L are diagrams of an example implementation 300 of forming the semiconductor photonics device 100 described herein. In particular, the example implementation 300 includes an example of forming the dielectric waveguide structure 108 of the semiconductor photonics device 100 prior to formation of the semiconductor photonics components of the semiconductor photonics device 100 such as the semiconductor waveguide structure 112. The semiconductor photonics components such as the semiconductor waveguide structure 112 are formed above the dielectric waveguide structure 108 in the semiconductor photonics device 100. The example implementation 300 includes an example of patterning the dielectric layer 106 and forming the dielectric waveguide structure 108 from the dielectric layer 106 prior to forming or providing a top semiconductor layer from which the semiconductor photonics components such as the semiconductor waveguide structure 112 are formed.

In some implementations, one or more operations described in connection with FIGS. 3A-3L are performed using a semiconductor processing tool, such as a deposition tool, an exposure tool, a developer tool, an etch tool, a planarization tool, a bonding tool, and/or an annealing tool, among other examples. In some implementations, one or more operations described in connection with FIGS. 3A-3L may be performed to form another semiconductor photonics device described herein, such as the semiconductor photonics device 400 illustrated and described in connection with FIGS. 4A-4C, the semiconductor photonics device 500 illustrated and described in connection with FIGS. 5A and 5B, the semiconductor photonics device 600 illustrated and described in connection with FIGS. 6A-6C, the semiconductor photonics device 700 illustrated and described in connection with FIGS. 7A and 7B, the semiconductor photonics device 800 illustrated and described in connection with FIG. 8, the semiconductor photonics device 900 illustrated and described in connection with FIGS. 9A and 9B, the semiconductor photonics device 1000 illustrated and described in connection with FIGS. 10A and 10B, and/or the semiconductor photonics device 1100 illustrated and described in connection with FIG. 11, among other examples.

As shown in FIG. 3A, similar processing operations as described in connection with FIGS. 2A-2D may be performed to form the dielectric layers 104, 106, and 206 on the semiconductor substrate 102.

As shown in FIG. 3B, a masking layer 302 is formed on the dielectric layer 206. In some implementations, the masking layer 302 includes a photoresist layer, and a deposition tool is used to form the masking layer 302 using a spin-coating technique. In some implementations, the masking layer 302 includes a hard mask layer, and a deposition tool is used to form the masking layer 302 using a PVD technique, a CVD technique, an atomic layer deposition (ALD) technique, and/or another suitable deposition technique.

As shown in FIG. 3C, a pattern 304 may be formed in the masking layer 302. The pattern 304 may be formed for use in etching the dielectric layer 106 to remove portions of the dielectric layer 106 and to form the dielectric waveguide structure 108 in the dielectric layer 106 prior to providing or attaching the semiconductor layer 216 to the semiconductor photonics device 100.

In implementations in which the masking layer 302 is a photoresist layer, the pattern 304 may be formed in the masking layer 302 by using an exposure tool to expose the masking layer 302 to a radiation source and using a developer tool to develop and remove portions of the masking layer 302 to expose the pattern 304.

In implementations in which the masking layer 302 is a hard mask layer, the pattern 304 may be first formed in a photoresist layer and then transferred to the masking layer 302 by etching. A deposition tool may be used to form the photoresist layer on the masking layer 302. An exposure tool may be used to expose the photoresist layer to a radiation source to pattern the photoresist layer. A developer tool may be used to develop and remove portions of the photoresist layer to expose the pattern 304. An etch tool may be used to etch the masking layer 302 based on the pattern 304 in the photoresist layer to transfer the pattern 304 to the masking layer 302. In some implementations, a photoresist removal tool may be used to remove the remaining portions of the photoresist layer (e.g., using a chemical stripper, plasma ashing, and/or another technique).

As shown in FIGS. 3D and 3E, the pattern 304 in the masking layer 302 is used to etch the dielectric layers 106 and 206 to define the dielectric waveguide structure 108 and to remove portions of the dielectric layer 106 above which the semiconductor waveguide structure 112 and/or other semiconductor photonics components described herein are to be formed in the semiconductor layer 216. In this way, the dielectric waveguide structure 108 is formed prior to the semiconductor layer 216 being provided on the semiconductor photonics device 100.

As shown in FIGS. 3F and 3G, additional material of the dielectric layer 206 may be deposited to backfill the areas of the dielectric layers 106 and 206 that were removed. In some implementations, a planarization tool is used to perform a CMP operation to planarize the dielectric layer 206 after the additional material of the dielectric layer 206 is deposited.

As shown in FIG. 3H, the wafer stack 208, including the semiconductor layer 216, is bonded to the semiconductor photonics device 100 after the dielectric layers 106 and 206 are etched to form the dielectric waveguide structure 108. The wafer stack 208 may be bonded to the semiconductor photonics device 100 in a similar manner as described in connection with FIG. 2E.

As shown in FIG. 3I, the carrier wafer 210 and the etch stop layers 212 and 214 may be removed from the semiconductor photonics device 100 after bonding the wafer stack 208 to the semiconductor photonics device 100. The carrier wafer 210 and the etch stop layers 212 and 214 may be removed using one or more techniques described in connection with FIGS. 2F and 2G. A planarization tool may be used to planarize the semiconductor layer 216 after the carrier wafer 210 and the etch stop layers 212 and 214 are removed.

As shown in FIG. 3J, the semiconductor layer 216 may be patterned and etched to form the semiconductor waveguide structure 112 and/or other semiconductor photonics components described herein. The semiconductor layer 216 may be patterned and etched using techniques described in connection with FIG. 2I.

As shown in FIG. 3K, additional material of the dielectric layer 110 is formed over the semiconductor waveguide structure 112 to encapsulate the semiconductor waveguide structure 112 in dielectric material. Techniques described in connection with FIG. 2K may be used to deposit the additional material of the dielectric layer 110. In some implementations, the buffer layers 202 and/or 204 may be removed from the semiconductor substrate 102. In some implementations, the buffer layers 202 and/or 204 are retained in the semiconductor photonics device 100.

As shown in FIG. 3L, pre-patterning the dielectric layer 106 prior to providing the semiconductor layer 216 enables portions of the dielectric layer 106 to be removed so that the dielectric layer 106 is not included under the semiconductor waveguide structure 112 and/or other semiconductor photonics components described herein. The process flow illustrated in FIGS. 2A-2K may involve fewer processing operations than the process flow illustrated in FIGS. 3A-3L, and therefore may be lower in complexity, cost, and/or time, than the process flow illustrated in FIGS. 3A-3L. On the other hand, the process flow illustrated in FIGS. 3A-3L may enable lower optical loss to be achieved for the dielectric waveguide structure and/or for the semiconductor waveguide structure 112 than the process flow illustrated in FIGS. 2A-2K.

As indicated above, FIGS. 3A-3L are provided as an example. Other examples may differ from what is described with regard to FIGS. 3A-3L.

FIGS. 4A-4C are diagrams of an example of a semiconductor photonics device 400 described herein. The semiconductor photonics device 400 may include a photonic integrated circuit that includes a similar arrangement of structures and layers as the semiconductor photonics device 100, such as a dielectric waveguide structure 108 and a semiconductor waveguide structure 112 above the dielectric waveguide structure 108. The dielectric waveguide structure 108 and the semiconductor waveguide structure 112 are formed using processing techniques described herein (such as in connection with FIGS. 2A-2K and/or 3A-3L) such that the dielectric waveguide structure 108 is formed prior to semiconductor waveguide structure 112 and other semiconductor photonics components of the semiconductor photonics device 400. This enables advanced shapes and/or profiles, such as a vertical taper, to be implemented in the semiconductor waveguide structure 112 to increase the coupling efficiency of optical signal coupling between the dielectric waveguide structure 108 and the semiconductor waveguide structure 112.

FIG. 4A illustrates a perspective view of the semiconductor photonics device 400. FIG. 4B illustrates a top view of the semiconductor photonics device 400. FIG. 4C illustrates a cross-sectional view of the semiconductor photonics device 400 along the line A-A in the x-direction in FIG. 4B.

As shown in FIGS. 4A-4C, the semiconductor waveguide structure 112 includes a strip waveguide section 402 and a transition section 404 laterally adjacent to the strip waveguide section 402 in the x-direction in the semiconductor photonics device 400. The strip waveguide section 402 includes an elongated waveguide structure with an approximately uniform z-direction thickness. The transition section 404 includes a tapered waveguide section having a vertical (z-direction) taper from a first end of the transition section 404 coupled to the strip waveguide section 402 to a second end of the transition section 404 opposite the first end. Thus, the z-direction thickness of the transition section 404 decreases from the first end to the second end. In particular, the z-direction thickness of the transition section 404 decreases from the first end to the second end in a manner in which the top surface of the transition section 404 decreases in z-direction height from the first end to the second end, and such that the bottom surface of the transition section 404 remains at substantially the same z-direction height from the first end to the second end. This may be referred to as a downward taper in the transition section 404.

As shown in FIGS. 4A-4C, the semiconductor waveguide structure 112 extends laterally over the dielectric waveguide structure 108 such that the transition section 404 of the semiconductor waveguide structure 112 is located over and partially overlaps with a portion of the dielectric waveguide structure 108. As shown in FIG. 4C, the downward taper of the transition section 404 promotes optical signals 114 to propagate downward in the transition section 404 toward the dielectric waveguide structure 108, which increases coupling efficiency between the dielectric waveguide structure 108 and the semiconductor waveguide structure 112.

Forming the semiconductor waveguide structure 112 to have the downward taper in the transition section 404 is at least partially enabled by the dielectric waveguide structure 108 being located below the semiconductor waveguide structure 112. When forming the semiconductor waveguide structure 112, a semiconductor layer 216 may be patterned and etched in a manner in which the top surface of the transition section 404 gradually decreases in z-direction height from the first end to the second end such that the transition section 404 tapers downward toward the underlying dielectric waveguide structure 108. If the dielectric waveguide structure 108 were formed above the semiconductor waveguide structure 112, the downward taper of the transition section 404 would cause the transition section 404 to taper away from the underlying dielectric waveguide structure 108, resulting in reduced coupling efficiency and increased optical loss.

The slope of the downward taper in the transition section 404 may be based on one or more parameters associated with the dielectric waveguide structure 108 and/or one or more parameters associated with the semiconductor waveguide structure 112. For example, the slope of the downward taper in the transition section 404 may be based on the z-direction thickness of the dielectric waveguide structure 108 and/or the z-direction thickness of the semiconductor waveguide structure 112. As another example, the slope of the downward taper in the transition section 404 may be based on the y-direction width of the dielectric waveguide structure 108 and/or the y-direction thickness of the semiconductor waveguide structure 112. As another example, the slope of the downward taper in the transition section 404 may be based on the refractive index of the dielectric waveguide structure 108 and/or the refractive index of the semiconductor waveguide structure 112. As another example, the slope of the downward taper in the transition section 404 may be based on the material of the dielectric waveguide structure 108 and/or the material of the semiconductor waveguide structure 112. As another example, the slope of the downward taper in the transition section 404 may be based on the z-direction spacing and/or the x-direction spacing between the dielectric waveguide structure 108 and the semiconductor waveguide structure 112.

While the example in FIGS. 4A-4C illustrates the semiconductor waveguide structure 112 being located above a remaining portion of the dielectric layer 106, the dielectric layer 106 may be etched (e.g., as illustrated in the example in FIGS. 3A-3L) such that the dielectric layer 106 is removed and the semiconductor waveguide structure 112 is formed without the dielectric layer 106 being under the semiconductor waveguide structure 112.

As indicated above, FIGS. 4A-4C are provided as an example. Other examples may differ from what is described with regard to FIGS. 4A-4C.

FIGS. 5A and 5B are diagrams of an example of a semiconductor photonics device 500 described herein. The semiconductor photonics device 500 may include a photonic integrated circuit that includes a similar arrangement of structures and layers as the semiconductor photonics device 400, such as a dielectric waveguide structure 108 and a semiconductor waveguide structure 112 above the dielectric waveguide structure 108, and the semiconductor waveguide structure 112 includes a strip waveguide section 402 and transition section 404.

As further shown in FIGS. 5A and 5B, the transition section 404 is laterally tapered in the y-direction in addition to being vertically tapered in the z-direction. In particular, the lateral y-direction width decreases from the first end of the transition section 404 coupled to the strip waveguide section 402 to the second end opposing the first end, similar to the z-direction thickness of the transition section 404. The combination of the lateral taper in the y-direction and the vertical taper in the z-direction promotes further confinement of optical signals 114 in the transition section 404, in addition to promoting the downward propagation of the optical signals 114 in the transition section 404 toward the dielectric waveguide structure 108, which further increases coupling efficiency between the dielectric waveguide structure 108 and the semiconductor waveguide structure 112.

The lateral taper of the transition section 404 may be formed by forming a masking layer over the strip waveguide section 402 and over the transition section 404, patterning the masking layer on the transition section 404, and etching the transition section 404 based on the patterned masking layer to form the lateral taper of the transition section 404. In some implementations, the lateral taper of the transition section 404 is formed prior to formation of the vertical taper of the transition section 404. In some implementations, the lateral taper of the transition section 404 is formed after formation of the vertical taper of the transition section 404.

While the example in FIGS. 5A and 5B illustrates the semiconductor waveguide structure 112 being located above a remaining portion of the dielectric layer 106, the dielectric layer 106 may be etched (e.g., as illustrated in the example in FIGS. 3A-3L) such that the dielectric layer 106 is removed and the semiconductor waveguide structure 112 is formed without the dielectric layer 106 being under the semiconductor waveguide structure 112.

As indicated above, FIGS. 5A and 5B are provided as an example. Other examples may differ from what is described with regard to FIGS. 5A and 5B.

FIGS. 6A-6C are diagrams of an example of a semiconductor photonics device 600 described herein. The semiconductor photonics device 600 may include a photonic integrated circuit that includes a similar arrangement of structures and layers as the semiconductor photonics device 400, such as a dielectric waveguide structure 108 and a semiconductor waveguide structure 112 above the dielectric waveguide structure 108, and the semiconductor waveguide structure 112 includes a strip waveguide section 402 and transition section 404. The dielectric waveguide structure 108 and the semiconductor waveguide structure 112 are formed using processing techniques described herein (such as in connection with FIGS. 2A-2K and/or 3A-3L) such that the dielectric waveguide structure 108 is formed prior to semiconductor waveguide structure 112 and other semiconductor photonics components of the semiconductor photonics device 600. This enables advanced shapes and/or profiles, such as a stepped profile, to be implemented in the transition section 404 semiconductor waveguide structure 112 to increase the coupling efficiency of optical signal coupling between the dielectric waveguide structure 108 and the semiconductor waveguide structure 112.

FIG. 6A illustrates a perspective view of the semiconductor photonics device 600. FIG. 6B illustrates a top view of the semiconductor photonics device 600. FIG. 6C illustrates a cross-section view of the semiconductor photonics device 600 along the line A-A in the x-direction in FIG. 6B.

As shown in FIGS. 6A-6C, the transition section 404 of the semiconductor waveguide structure 112 has a stepped profile such that the transition section 404 includes a plurality of vertical steps 602. The steps 602 of the transition section 404 of the semiconductor waveguide structure 112 may extend laterally over the dielectric waveguide structure 108 such that one or more of the steps 602 of the transition section 404 of the semiconductor waveguide structure 112 are located over and partially overlap with a portion of the dielectric waveguide structure 108.

The steps 602 may be vertical steps in that the z-direction height of the steps 602 decreases from the first end of the transition section 404 coupled to the strip waveguide section 402 to the second end opposing the first end. For example, as shown in FIG. 6B, the transition section 404 may include steps 602a, 602b, and 602c. As shown in FIG. 6C, the top surface of the step 602b may be located at a lower z-direction height than the z-direction height of the top surface of the step 602a, and the top surface of the step 602c may be located at a lower z-direction height than the z-direction height of the top surface of the step 602b. The bottom surface of the transition section 404 remains at substantially the same z-direction height from the first end to the second end. Thus, the transition section 404 steps downward from the first end to the second end. This results in the z-direction thickness of the transition section 404 decreasing from the first end to the second end. This promotes propagation of optical signals 114 downward in the transition section 404 toward the dielectric waveguide structure 108, which increases coupling efficiency between the dielectric waveguide structure 108 and the semiconductor waveguide structure 112.

Forming the semiconductor waveguide structure 112 such that transition section 404 is stepped downward from the first end to the second end is at least partially enabled by the dielectric waveguide structure 108 being located below the semiconductor waveguide structure 112. When forming the semiconductor waveguide structure 112, a semiconductor layer 216 may be patterned and etched in a manner in which the top surface of the transition section 404 decreases in z-direction height in steps 602 from the first end to the second end downward toward the underlying dielectric waveguide structure 108. If the dielectric waveguide structure 108 were formed above the semiconductor waveguide structure 112, the downward steps 602 of the transition section 404 would cause the transition section 404 to be stepped away from the underlying dielectric waveguide structure 108, resulting in reduced coupling efficiency and increased optical loss.

The quantity of steps 602 in the transition section 404, the z-direction height of the steps 602, and/or the x-direction length of the steps 602 may be based on one or more parameters associated with the dielectric waveguide structure 108 and/or one or more parameters associated with the semiconductor waveguide structure 112, such as the z-direction thickness of the dielectric waveguide structure 108 and/or the z-direction thickness of the semiconductor waveguide structure 112, the y-direction width of the dielectric waveguide structure 108 and/or the y-direction thickness of the semiconductor waveguide structure 112, the refractive index of the dielectric waveguide structure 108 and/or the refractive index of the semiconductor waveguide structure 112, the material of the dielectric waveguide structure 108 and/or the material of the semiconductor waveguide structure 112, the z-direction spacing and/or the x-direction spacing between the dielectric waveguide structure 108 and the semiconductor waveguide structure 112, and/or another parameter.

While the example in FIGS. 6A-6C illustrates the semiconductor waveguide structure 112 being located above a remaining portion of the dielectric layer 106, the dielectric layer 106 may be etched (e.g., as illustrated in the example in FIGS. 3A-3L) such that the dielectric layer 106 is removed and the semiconductor waveguide structure 112 is formed without the dielectric layer 106 being under the semiconductor waveguide structure 112.

As indicated above, FIGS. 6A-6C are provided as an example. Other examples may differ from what is described with regard to FIGS. 6A-6C.

FIGS. 7A and 7B are diagrams of an example of a semiconductor photonics device 700 described herein. The semiconductor photonics device 700 may include a photonic integrated circuit that includes a similar arrangement of structures and layers as the semiconductor photonics device 600, such as a dielectric waveguide structure 108 and a semiconductor waveguide structure 112 above the dielectric waveguide structure 108, and the semiconductor waveguide structure 112 includes a strip waveguide section 402 and transition section 404 that includes a plurality of steps 602.

As further shown in FIGS. 7A and 7B, the transition section 404 is laterally tapered in the y-direction in addition to being vertically stepped in the z-direction. In particular, the lateral y-direction width decreases from the first end of the transition section 404 coupled to the strip waveguide section 402 to the second end opposing the first end, similar to the decrease in z-direction height of the steps 602 of the transition section 404. The combination of the lateral taper in the y-direction and the vertical steps 602 in the z-direction promotes further confinement of optical signals 114 in the transition section 404, in addition to promoting the downward propagation of the optical signals 114 in the transition section 404 toward the dielectric waveguide structure 108, which further increases coupling efficiency between the dielectric waveguide structure 108 and the semiconductor waveguide structure 112.

The lateral taper of the transition section 404 may be formed by forming a masking layer over the strip waveguide section 402 and over the transition section 404, patterning the masking layer on the transition section 404, and etching the transition section 404 based on the patterned masking layer to form the lateral taper of the transition section 404. In some implementations, the lateral taper of the transition section 404 is formed prior to formation of the steps 602 of the transition section 404. In some implementations, the lateral taper of the transition section 404 is formed after formation of the steps 602 of the transition section 404.

While the example in FIGS. 7A and 7B illustrates the semiconductor waveguide structure 112 being located above a remaining portion of the dielectric layer 106, the dielectric layer 106 may be etched (e.g., as illustrated in the example in FIGS. 3A-3L) such that the dielectric layer 106 is removed and the semiconductor waveguide structure 112 is formed without the dielectric layer 106 being under the semiconductor waveguide structure 112.

As indicated above, FIGS. 7A and 7B are provided as an example. Other examples may differ from what is described with regard to FIGS. 7A and 7B.

FIG. 8 is a diagram of an example of a semiconductor photonics device 800 described herein. The semiconductor photonics device 800 may include a photonic integrated circuit that includes a similar arrangement of structures and layers as the semiconductor photonics device 100, such as a dielectric waveguide structure 108 and a semiconductor waveguide structure 112 above the dielectric waveguide structure 108. The dielectric waveguide structure 108 and the semiconductor waveguide structure 112 are formed using processing techniques described herein (such as in connection with FIGS. 2A-2K and/or 3A-3L) such that the dielectric waveguide structure 108 is formed prior to semiconductor waveguide structure 112 and other semiconductor photonics components of the semiconductor photonics device 800. This enables advanced shapes and/or profiles, such as a vertical taper, to be implemented in the semiconductor waveguide structure 112 to increase the coupling efficiency of optical signal coupling between the dielectric waveguide structure 108 and the semiconductor waveguide structure 112.

As further shown in FIG. 8, the semiconductor waveguide structure 112 may include a rib waveguide structure having a base section 802 and a core section 804 on top of the base section 802. The semiconductor waveguide structure 112 in the semiconductor photonics device 800 may be formed by forming a first patterned masking layer on a semiconductor layer 216 and etching the semiconductor layer 216 based on the first patterned masking layer to form the base section 802, and then forming a second patterned masking layer on the semiconductor layer 216 and etching the semiconductor layer 216 based on the second patterned masking layer to form the core section 804. Alternatively, the first patterned masking layer may be used to etch the semiconductor layer 216 to form the core section 804, and then the second patterned masking layer may be used to etch the semiconductor layer 216 to form the base section 802.

While the example in FIG. 8 illustrates the semiconductor waveguide structure 112 being located above a remaining portion of the dielectric layer 106, the dielectric layer 106 may be etched (e.g., as illustrated in the example in FIGS. 3A-3L) such that the dielectric layer 106 is removed and the semiconductor waveguide structure 112 is formed without the dielectric layer 106 being under the semiconductor waveguide structure 112.

As indicated above, FIG. 8 is provided as an example. Other examples may differ from what is described with regard to FIG. 8.

FIGS. 9A and 9B are diagrams of an example of a semiconductor photonics device 900 described herein. FIG. 9A illustrates a cross-section view of the semiconductor photonics device 900 in a y-z plane, and FIG. 9B illustrates a cross-section view of the semiconductor photonics device 900 in an x-z plane. The semiconductor photonics device 900 may include a photonic integrated circuit that includes a similar arrangement of structures and layers as the semiconductor photonics device 100, such as a dielectric waveguide structure 108 and a semiconductor waveguide structure 112 above the dielectric waveguide structure 108. The dielectric waveguide structure 108 and the semiconductor waveguide structure 112 are formed using processing techniques described herein (such as in connection with FIGS. 2A-2K and/or 3A-3L) such that the dielectric waveguide structure 108 is formed prior to semiconductor waveguide structure 112 and other semiconductor photonics components of the semiconductor photonics device 900.

As further shown in FIG. 9A, the semiconductor photonics device 900 includes additional semiconductor photonics components such as an optical modulator structure 902 and a grating coupler 904. The optical modulator structure 902 and the grating coupler 904 may be formed from a semiconductor layer 216 above the dielectric layer 106 and above the BOX portion of the dielectric layer 110, in addition to the semiconductor waveguide structure 112 being formed from the semiconductor layer 216. The semiconductor waveguide structure 112 may include one or more implementations of the semiconductor waveguide structure 112 illustrated and described herein.

The optical modulator structure 902 may be located laterally adjacent to the semiconductor waveguide structure 112 in the y-direction in the semiconductor photonics device 900. The optical modulator structure 902 may include a micro-ring modulator (MRM), a Mach-Zender modulator (MZM), and/or another type of optical modulator that includes a semiconductor waveguide structure that is electrically coupled to a set of electrical contacts. The optical modulator structure 902 may be configured to encode data onto an input optical signal 906 for optical communication.

The input optical signal 906 may be transferred from the grating coupler 904 to the optical modulator structure 902. The grating coupler 904 may include a semiconductor structure (e.g., a silicon (Si) structure and/or other types of semiconductor structure) that is configured to receive the input optical signal from an input optical fiber 908 or another type of external optical connection. The input optical fiber 908 may be located at a top of the semiconductor photonics device 900 (e.g., as shown in the example in FIG. 9A), may be located at a side of the semiconductor photonics device 900, and/or may be located at another location. The grating coupler 904 may redirect the input optical signal 906 from the input optical fiber 908 toward the optical modulator structure 902. The grating coupler 904 may be configured to diffract the input optical signal 906 from an off-plane direction (e.g., a z-direction) in the semiconductor photonics device 900 to an in-plane direction (e.g., a y-direction) that is in the plane of the optical modulator structure 902. The grating coupler 904 may include a plurality of periodic gratings. The periodicity and design of the periodic gratings may be selected to achieve diffraction of one or more wavelengths of the input optical signal 906. In some implementations, the periodicity of the periodic gratings may be selected based on the wavelength of the input optical signal 906.

The optical modulator structure 902 may modulate the input optical signal 906 based on an input electrical signal 910 to generate a modulated optical signal 912. The optical modulator structure 902 may modulate the amplitude of the input optical signal 906, the phase of the input optical signal 906, and/or another property of the input optical signal 906 based on the input electrical signal 910.

The input electrical signal 910 may be provided to contacts 914 and/or 916 of the optical modulator structure 902. The contacts 914 and/or 916 may include one or more types of doped semiconductor materials. For example, the contact 914 may be a p-doped contact (e.g., may include a semiconductor material that is doped with one or more p-type dopants), and the contact 916 may be an n-doped contact (e.g., may include a semiconductor material that is doped with one or more n-type dopants). Thus, the optical modulator structure 902 may include a P-N junction. The semiconductor material may include silicon (Si), germanium (Ge), silicon germanium (SiGe), and/or another semiconductor material. The p-type dopant(s) may include p-type ions of a p-type material (e.g., boron (B) or germanium (Ge), among other examples). The n-type dopant(s) may include n-type ions of an n-type material (e.g., phosphorous (P) or arsenic (As), among other examples).

When the input electrical signal 910 is applied to the P-N junction of the optical modulator structure 902, a junction depletion width of the P-N junction is modified. This results in changes in concentrations of electrons and holes within the optical modulator structure 902. The changes in concentrations of electrons and holes may lead to changes of the effective refractive index of the optical modulator structure 902, which may modulate the input optical signal 906 (e.g., the phase and/or another property of the input optical signal 906) to generate the modulated optical signal 912.

Alternatively, the optical modulator structure 902 may include a thermo-optic modulator that modulates the input optical signals 906 based on changes in temperature in the semiconductor waveguide structure of the optical modulator structure 902. In these implementations, the contacts 914 and 916 of the optical modulator structure 902 may be coupled to a heater structure that generates heat that is provided to the semiconductor waveguide structure of the optical modulator structure 902.

The contacts 914 and 916 of the optical modulator structure 902 may be electrically coupled and/or physically coupled to interconnect structures 918 and 920, respectively, that are included in the dielectric layer 110. Input electrical signals 910 may be provided to the contacts 914 and 916 through the interconnect structures 918 and 920. The interconnect structures 918 and 920 may each include one or more electrically conductive materials, such as tungsten (W), cobalt (Co), ruthenium (Ru), titanium (Ti), aluminum (Al), copper (Cu), and/or gold (Au), among other examples of conductive materials. The interconnect structures 918 and 920 may each include vias, trenches, contact plugs, and/or another type of conductive structures.

In some implementations, metal silicide layers may be included between the contact 914 and the interconnect structure 918 and/or between the contact 916 and the interconnect structure 920. The metal silicide layers may include a titanium silicide (TiSi), a ruthenium silicide (RuSi), and/or another type of metal silicide material. The metal silicide layers provide a transition between the semiconductor material of the contacts 914 and 916, and the metal material of the interconnect structures 918 and 920, thereby enabling a low contact resistance to be achieved between the contact 914 and the interconnect structure 916 and/or between the contact 916 and the interconnect structure 920. The metal silicide layers may be formed by depositing a metal layer on the contacts 914 and 916 and performing an annealing operation to achieve salicidation of the metal layer and the semiconductor material of the contacts 914 and 916, resulting in formation of the metal silicide layers.

As described herein, forming the dielectric waveguide structure 108 in the dielectric layer 106 prior to formation of semiconductor photonics components such as the optical modulator structure 902 prevents, minimizes, and/or reduces the likelihood of damage and/or degradation to the semiconductor photonics components such as the optical modulator structure 902. For the optical modulator structure 902, if the dielectric waveguide structure 108 were to be formed after the metal silicide layers of the optical modulator structure 902 and using high-temperature process techniques such as LPCVD and/or annealing, the high-temperature process techniques might otherwise result in damage to the metal silicide layers and/or to the semiconductor structure of the optical modulator structure 902. For example, the high-temperature process techniques used for forming the dielectric waveguide structure 108 may cause further (unwanted) diffusion of metal atoms of the metal layer into the semiconductor structure of the optical modulator structure 902, thereby negatively alternating the electrical properties of the optical modulator structure 902. Forming the dielectric waveguide structure 108 in the dielectric layer 106 prior to formation of semiconductor photonics components such as the optical modulator structure 902 enables high-temperature process techniques to be used for forming the dielectric waveguide structure 108 since the metal silicide layers and other temperature-sensitive structures and/or layers of the optical modulator structure 902 and/or other semiconductor photonics components have not yet been formed.

An interconnect layer 922 may be included above the dielectric layer 110. The interconnect layer 922 may include a back end region or a back end of line (BEOL) region of the semiconductor photonics device 900. The interconnect layer 922 may include one or more dielectric layers 924 and one or more metallization layers 926 in the one or more dielectric layers 924. The interconnect structures 918 and 920 may be electrically coupled and/or physically coupled with one or more metallization layers 926 in the one or more dielectric layers 924 of the interconnect layer 922. The input electrical signals 910 may be provided to the optical modulator structure 902 through the metallization layer(s) 926. The metallization layer(s) 926 correspond to circuitry that enables signals and/or power to be provided to and/or from the optical modulator structure 902 and/or other devices in the semiconductor photonics device 900. The metallization layer(s) 926 may each include one or more electrically conductive materials, such as tungsten (W), cobalt (Co), ruthenium (Ru), titanium (Ti), aluminum (Al), copper (Cu), and/or gold (Au), among other examples of conductive materials. The metallization layer(s) 926 may each include vias, trenches, contact plugs, conductive pads, conductive pillars, and/or another type of metallization layers. The dielectric layer(s) 924 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), and/or another dielectric material.

As further shown in FIG. 9A, an additional waveguide structure 928 (e.g., a semiconductor waveguide structure, a dielectric waveguide structure) may be included between the optical modulator structure 902 and the grating coupler 904 to facilitate the propagation of the input optical signals 906 from the grating coupler 904 to the optical modulator structure 902.

As shown in FIG. 9B, modulated optical signals 912 may be coupled from the semiconductor waveguide structure 112 to the dielectric waveguide structure 108, and may be coupled from the dielectric waveguide structure 108 to an output optical fiber 930 and/or another type of external optical connection. The modulated optical signals 912 may propagate in the x-direction and downward in the z-direction from the semiconductor waveguide structure 112 to the dielectric waveguide structure 108.

As indicated above, FIGS. 9A and 9B are provided as an example. Other examples may differ from what is described with regard to FIGS. 9A and 9B.

FIGS. 10A and 10B are diagrams of an example of a semiconductor photonics device 1000 described herein. FIG. 10A illustrates a cross-section view of the semiconductor photonics device 1000 in an x-z plane, and FIG. 10B illustrates a cross-section view of the semiconductor photonics device 1000 in a y-z plane. The semiconductor photonics device 1000 may include a photonic integrated circuit that includes a similar arrangement of structures and layers as the semiconductor photonics device 900, such as a dielectric waveguide structure 108 and a semiconductor waveguide structure 112 above the dielectric waveguide structure 108. The dielectric waveguide structure 108 and the semiconductor waveguide structure 112 are formed using processing techniques described herein (such as in connection with FIGS. 2A-2K and/or 3A-3L) such that the dielectric waveguide structure 108 is formed prior to semiconductor waveguide structure 112 and other semiconductor photonics components of the semiconductor photonics device 1000.

However, as shown in FIG. 10A, input optical signals 1002 may be provided from an input optical fiber 908 or another type of external optical connection to the dielectric waveguide structure 108, and from the dielectric waveguide structure 108 to the semiconductor waveguide structure 112. As shown in FIG. 10B, the input optical signals 1002 may be provided from the semiconductor waveguide structure 112 to a photodetector structure 1004. The photodetector structure 1004 may be formed from a semiconductor layer 216 above the dielectric layer 106 and above the BOX portion of the dielectric layer 110, in addition to the semiconductor waveguide structure 112 being formed from the semiconductor layer 216.

The photodetector structure 1004 includes a semiconductor photonics component that is configured to generate a current, a voltage, and/or another type of electrical output signal 1006 based on absorbed photons of light from the input optical signals 1002. The photodetector structure 1004 may include contacts 1008 and 1010 that correspond to collection regions for the electrical output signal 1006 generated by the photodetector structure 1004. For example, the contact 1008 may include a p-type doped collection region and the contact 1010 may include n-type doped collection region. The contacts 1008 and 1010 may be located at opposing sides of an absorption region of the photodetector structure 1004. The absorption region may be configured to absorb photons of the input optical signals 1002. The photons interact with electron-hole pairs in the absorption region. The interaction causes electrons and holes to be separated and to migrate toward opposing contacts 1008 and 1010 (e.g., opposing collection regions), resulting in the generation of an electric field (e.g., a built-in electric field). The photodetector structure 1004 may include a semiconductor waveguide structure coupled to the absorption region to direct the input optical signals 1002 toward the absorption region.

The absorption region and the associated semiconductor waveguide structure of the photodetector structure 1004 may each include a portion of the semiconductor layer 216. Alternatively, the absorption region may include an epitaxially grown region of semiconductor material that includes germanium (Ge), germanium tin (GeSn), silicon germanium (SiGe), indium gallium arsenide (InGaAs), and/or gallium arsenide (GaAs), among other examples.

As indicated above, FIGS. 10A and 10B are provided as an example. Other examples may differ from what is described with regard to FIGS. 10A and 10B.

FIG. 11 is a diagram of an example of a semiconductor photonics device 1100 described herein. The semiconductor photonics device 1100 may include a photonic integrated circuit that includes a similar arrangement of structures and layers as the semiconductor photonics device 100, such as a semiconductor substrate 102, dielectric layers 104, 106, and 110, and a dielectric waveguide structure 108 formed in the dielectric layer 106. However, the semiconductor photonics device 1100 includes a hybrid grating coupler structure 1102 instead of (or in addition to) the semiconductor waveguide structure 112. The hybrid grating coupler structure 1102 is a “hybrid” grating coupler in that the hybrid grating coupler structure 1102 includes a dual-layer structure having a dielectric portion 1104 formed in the dielectric layer 106 and a semiconductor portion 1106 formed in a top semiconductor layer (e.g., a semiconductor layer 216) above the dielectric layer 106 of the semiconductor photonics device 1100. The top semiconductor layer may be bonded to the semiconductor photonics device 1100, thereby enabling a monocrystalline semiconductor substrate to be used as the top semiconductor layer. This enables the semiconductor portion 1106 of the hybrid grating coupler structure 1102 to be formed of a single-crystal semiconductor material, which enables less optical scattering and lower optical loss to be achieved for the hybrid grating coupler structure 1102 than if an amorphous semiconductor layer were to be used for the top semiconductor layer.

The dual-layer structure of the hybrid grating coupler structure 1102 enables input optical signals 1108 to be directly coupled from the hybrid grating coupler structure 1102 to the dielectric waveguide structure 108 without an intervening semiconductor waveguide structure, which may increase the coupling efficiency and may reduce the optical signal loss between the hybrid grating coupler structure 1102 and the dielectric waveguide structure 108.

As shown in FIG. 11, the dielectric portion 1104 of the hybrid grating coupler structure 1102 includes a first plurality of gratings 1110 that are separated by recesses 1112. The gratings 1110 may be periodic, semi-periodic, and/or aperiodic. The semiconductor portion 1106 of the hybrid grating coupler structure 1102 includes a second plurality of gratings 1114 that are separated by regions of the dielectric layer 110. The gratings 1114 may be periodic, semi-periodic, and/or aperiodic. In some implementations, one or more of the gratings 1114 may be located directly over one or more of the gratings 1110. In some implementations, one or more of the gratings 1114 may be located directly over one or more of the recesses 1112. In some implementations, one or more of the gratings 1114 may be located partially over one or more of the gratings 1110. In some implementations, one or more of the gratings 1114 may be located partially over one or more of the recesses 1112.

The height of the gratings 1110 relative to a bottom surface of the dielectric portion 1104 (indicated in FIG. 11 as dimension D12), the height of the gratings 1110 relative to a bottom of the recesses 1112 (indicated in FIG. 11 as dimension D13), the spacing between the dielectric portion 1104 and the semiconductor portion 1106 of the hybrid grating coupler structure 1102 (indicated in FIG. 11 as dimension D14), the height of the gratings 1114 of the semiconductor portion 1106 (indicated in FIG. 11 as dimension D15), and/or a half width of the hybrid grating coupler structure 1102 (indicated in FIG. 11 as dimension D16) may be based on one or more parameters, such as the wavelength of the input optical signals 1108, the bandwidth of the input optical signals 1108, the angle of incidence of the input optical signals 1108 (indicated in FIG. 11 as dimension D17), the material of the dielectric portion 1104 of the hybrid grating coupler structure 1102, the refractive index of the dielectric portion 1104 of the hybrid grating coupler structure 1102, the material of the semiconductor portion 1106 of the hybrid grating coupler structure 1102, and/or the refractive index of the semiconductor portion 1106 of the hybrid grating coupler structure 1102, among other examples.

In some implementations, the height of the gratings 1110 relative to a bottom surface of the dielectric portion 1104 (dimension D12) is included in a range of approximately 100 nanometers to approximately 550 nanometers. However, other values and ranges for the height of the gratings 1110 relative to a bottom surface of the dielectric portion 1104 are within the scope of the present disclosure. In some implementations, the height of the gratings 1110 relative to a bottom of the recesses 1112 (dimension D13) is included in a range of approximately 100 nanometers to approximately 300 nanometers. However, other values and ranges for the height of the gratings 1110 relative to a bottom of the recesses 1112 are within the scope of the present disclosure.

In some implementations, the spacing between the dielectric portion 1104 and the semiconductor portion 1106 of the hybrid grating coupler structure 1102 (dimension D14) is included in a range of approximately 10 nanometers to approximately 250 nanometers. However, other values and ranges for the spacing between the dielectric portion 1104 and the semiconductor portion 1106 of the hybrid grating coupler structure 1102 are within the scope of the present disclosure. In some implementations, the height of the gratings 1114 of the semiconductor portion 1106 (dimension D15) is included in a range of approximately 50 nanometers to approximately 100 nanometers. However, other values and ranges for the height of the gratings 1114 of the semiconductor portion 1106 are within the scope of the present disclosure.

In some implementations, the half width of the hybrid grating coupler structure 1102 (dimension D16) is included in a range of approximately 5 microns to approximately 8 microns. However, other values and ranges for the half width of the hybrid grating coupler structure 1102 are within the scope of the present disclosure. In some implementations, the angle of incidence of the input optical signals 1108 (dimension D17) is included in a range of approximately 70 degrees to approximately 120 degrees. However, other values and ranges for the angle of incidence of the input optical signals 1108 are within the scope of the present disclosure.

As indicated above, FIG. 11 is provided as an example. Other examples may differ from what is described with regard to FIG. 11.

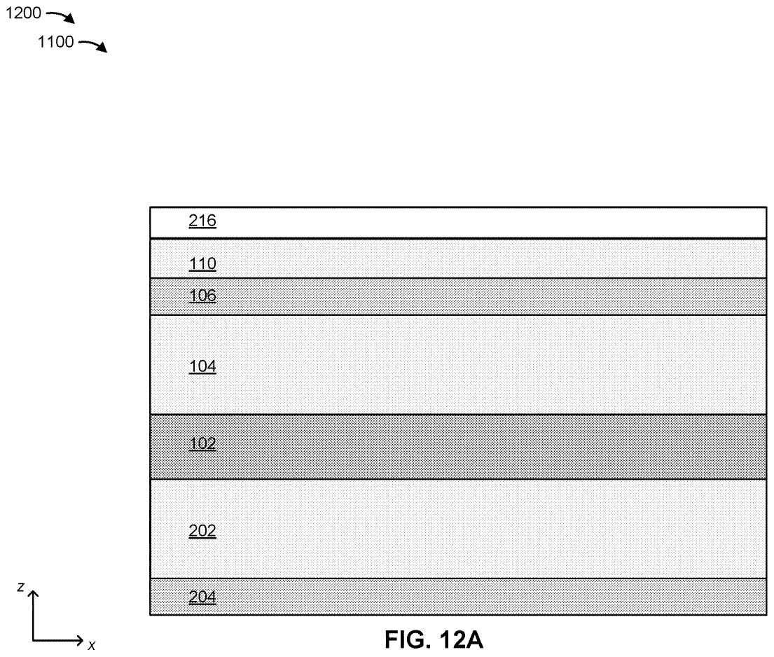

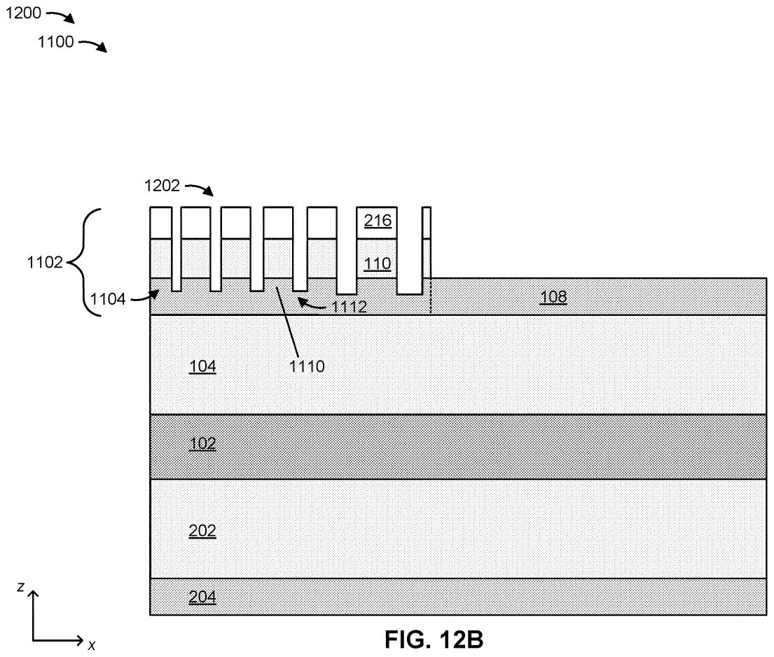

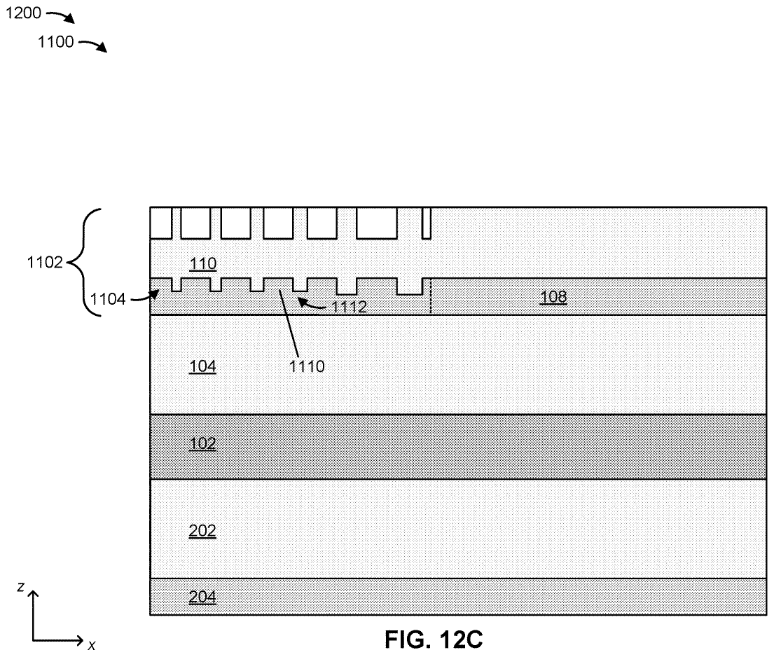

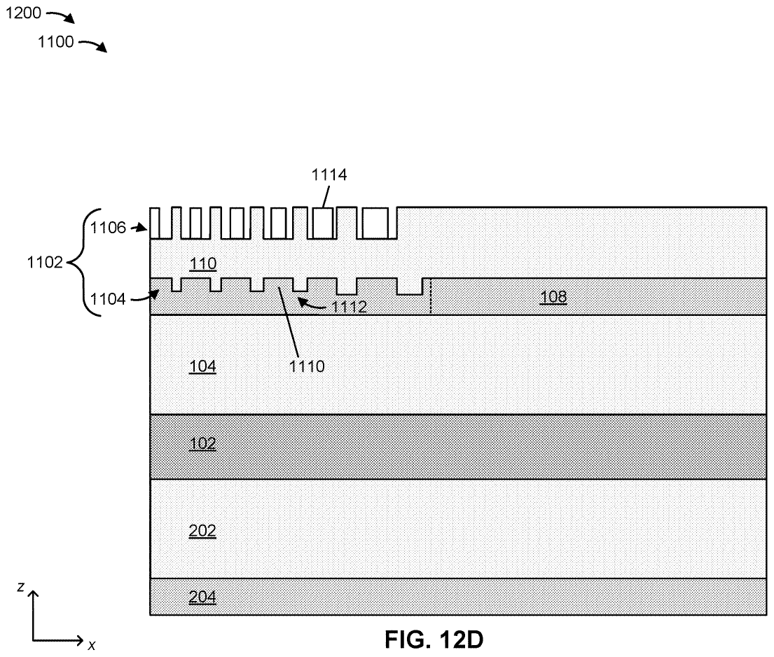

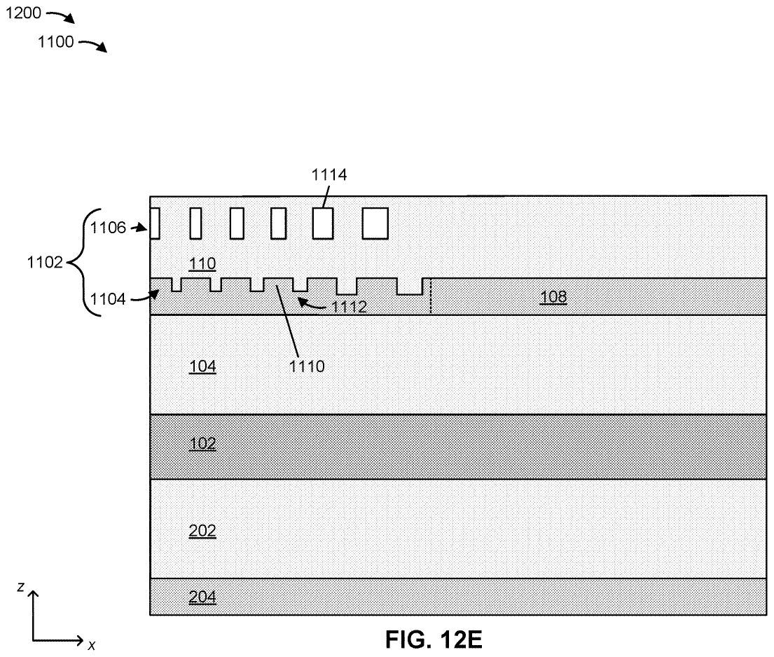

FIGS. 12A-12E are diagrams of an example implementation 1200 of forming the semiconductor photonics device 1100 described herein. In particular, the example implementation 1200 includes an example of forming the dielectric waveguide structure 108 and the dielectric portion 1104 of the hybrid grating coupler structure 1102 of the semiconductor photonics device 1100 prior to formation of the semiconductor photonics components of the semiconductor photonics device 1100 such as the semiconductor portion 1106 of the hybrid grating coupler structure 1102. The semiconductor photonics components such as the semiconductor portion 1106 of the hybrid grating coupler structure 1102 are formed above the dielectric waveguide structure 108 in the semiconductor photonics device 100. The example implementation 1200 includes an example of patterning the dielectric layer 106 and forming the dielectric waveguide structure 108 and the dielectric portion 1104 of the hybrid grating coupler structure 1102 from the dielectric layer 106 after forming or providing a top semiconductor layer from which the semiconductor photonics components such as the semiconductor portion 1106 of the hybrid grating coupler structure 1102 are formed.

In some implementations, one or more operations described in connection with FIGS. 12A-12E are performed using a semiconductor processing tool, such as a deposition tool, an exposure tool, a developer tool, an etch tool, a planarization tool, a bonding tool, and/or an annealing tool, among other examples. In some implementations, one or more operations described in connection with FIGS. 12A-12E may be performed to form another semiconductor photonics device described herein, such as the semiconductor photonics device 100 illustrated and described in connection with FIGS. 1A-1E, the semiconductor photonics device 400 illustrated and described in connection with FIGS. 4A-4C, the semiconductor photonics device 500 illustrated and described in connection with FIGS. 5A and 5B, the semiconductor photonics device 600 illustrated and described in connection with FIGS. 6A-6C, the semiconductor photonics device 700 illustrated and described in connection with FIGS. 7A and 7B, the semiconductor photonics device 800 illustrated and described in connection with FIG. 8, the semiconductor photonics device 900 illustrated and described in connection with FIGS. 9A and 9B, and/or the semiconductor photonics device 1000 illustrated and described in connection with FIGS. 10A and 10B, among other examples.

Turning to FIG. 12A, similar processing operations as described in connection with FIGS. 2A-2H may be performed to form the dielectric layers 104, 106, and 110, and to provide the semiconductor layer 216 on the semiconductor photonics device 1100.

As shown in FIG. 12B, the dielectric layers 106 and 110, and the semiconductor layer 216 may be etched to define the dielectric waveguide structure 108. Moreover, the dielectric layers 106 and 110, and the semiconductor layer 216 may be etched to define the dielectric portion 1104 of the hybrid grating coupler structure 1102.

In some implementations, the dielectric layers 106 and 110, and the semiconductor layer 216, may be etched to define the dielectric waveguide structure 108 in a similar manner as described in connection with FIGS. 2I and 2J. To define the dielectric portion 1104 of the hybrid grating coupler structure 1102, the dielectric layers 106 and 110, and the semiconductor layer 216 are etched to form recesses 1202 through the dielectric layers 106 and 110, and through the semiconductor layer 216, to form the gratings 1110 of the dielectric portion 1104 of the hybrid grating coupler structure 1102. The recesses 1202 extend into the dielectric layer 106 to form the recesses 1112 between the gratings 1110.

Thus, the dielectric waveguide structure 108 and the dielectric portion 1104 of the hybrid grating coupler structure 1102 are formed after the semiconductor layer 216 is provided on the semiconductor photonics device 100. Alternatively, the dielectric waveguide structure 108 may be formed prior to the semiconductor layer 216 being provided on the semiconductor photonics device 100.

In some implementations, a pattern in a photoresist layer is used to etch the dielectric layers 106 and 110, and the semiconductor layer 216, to form the recesses 1202. In these implementations, a deposition tool may be used to form the photoresist layer on the semiconductor layer 216. An exposure tool may be used to expose the photoresist layer to a radiation source to pattern the photoresist layer. A developer tool may be used to develop and remove portions of the photoresist layer to expose the pattern. An etch tool may be used to etch the dielectric layer 106, dielectric layer 110, and/or the semiconductor layer 216 based on the pattern to form the recesses 1202. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, respective patterned masking layers are used to etch each of the dielectric layer 106, dielectric layer 110, and the semiconductor layer 216.

As shown in FIG. 12C, additional material of the dielectric layer 110 may be deposited to backfill the areas of the dielectric layers 106 and 110 that were removed, and to backfill the areas of the semiconductor layer 216 that were removed. In some implementations, a planarization tool is used to perform a CMP operation to planarize the dielectric layer 110 after the additional material of the dielectric layer 110 is deposited. The additional material of the dielectric layer 110 also fills in the recesses 1112 between the gratings 1110 of the dielectric portion 1104 of the hybrid grating coupler structure 1102.

As shown in FIG. 12D, the semiconductor layer 216 is further etched to define the gratings 1114 of the semiconductor portion 1106 of the hybrid grating coupler structure 1102. In some implementations, a pattern in a photoresist layer is used to etch the semiconductor layer 216 to define the gratings 1114 of the semiconductor portion 1106 of the hybrid grating coupler structure 1102. In these implementations, a deposition tool may be used to form the photoresist layer on the semiconductor layer 216 and on the dielectric layer 110. An exposure tool may be used to expose the photoresist layer to a radiation source to pattern the photoresist layer. A developer tool may be used to develop and remove portions of the photoresist layer to expose the pattern. An etch tool may be used to etch the semiconductor layer 216 based on the pattern to form the gratings 1114. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique).

As shown in FIG. 12E, additional material of the dielectric layer 110 may be deposited to backfill the areas of the semiconductor layer 216 that were removed such that the semiconductor portion 1106 of the hybrid grating coupler structure 1102 is encapsulated in the dielectric layer 110. In some implementations, a planarization tool is used to perform a CMP operation to planarize the dielectric layer 110 after the additional material of the dielectric layer 110 is deposited.

As indicated above, FIGS. 12A-12E are provided as an example. Other examples may differ from what is described with regard to FIGS. 12A-12E.

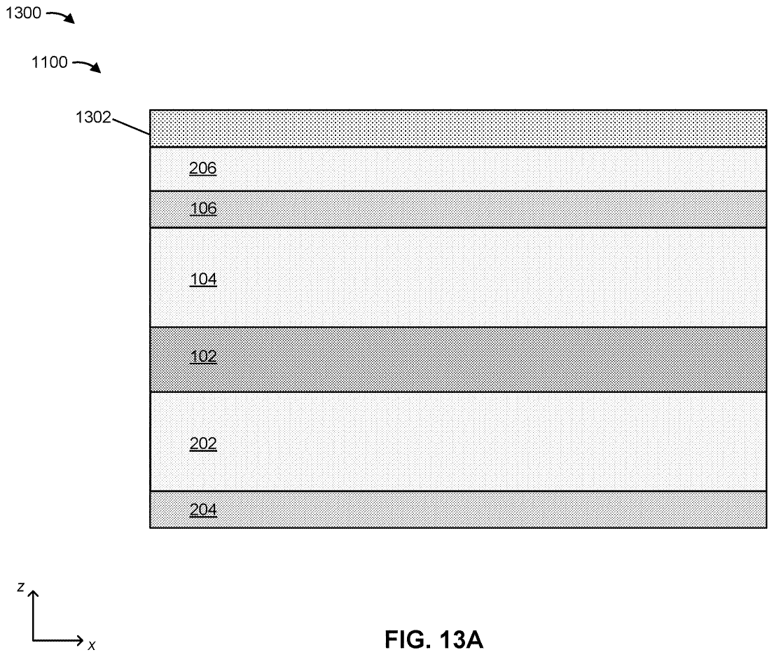

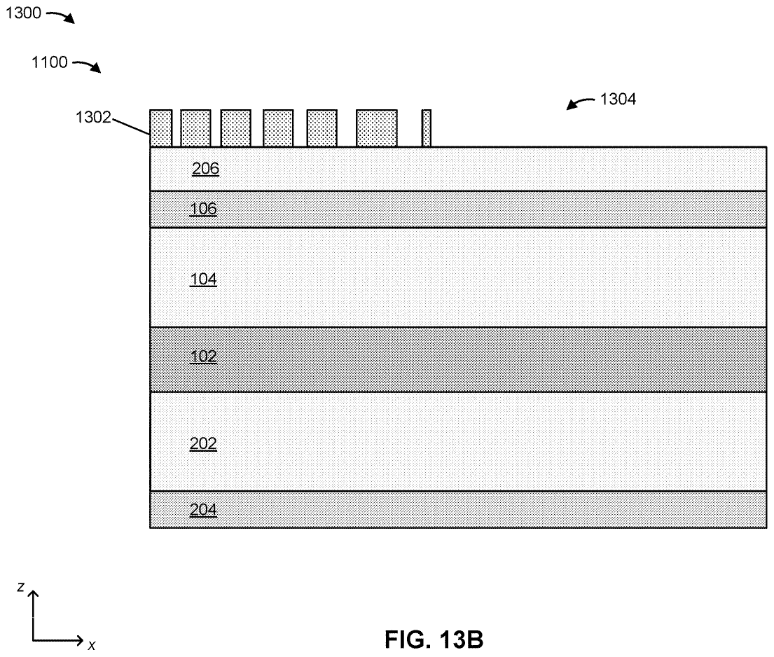

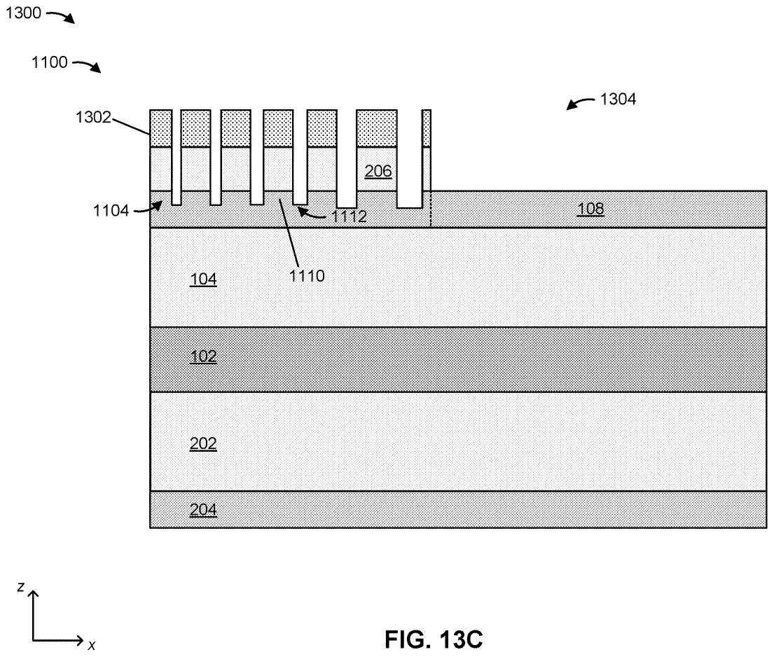

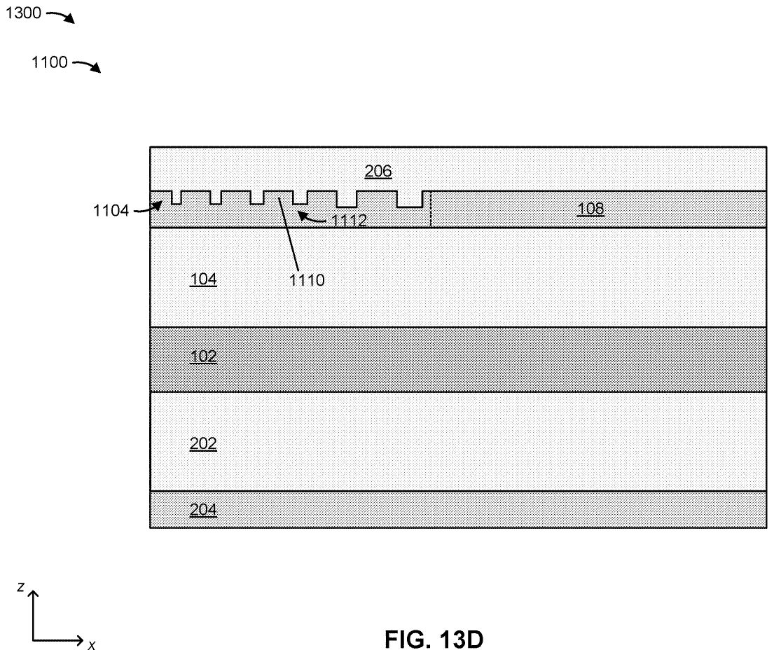

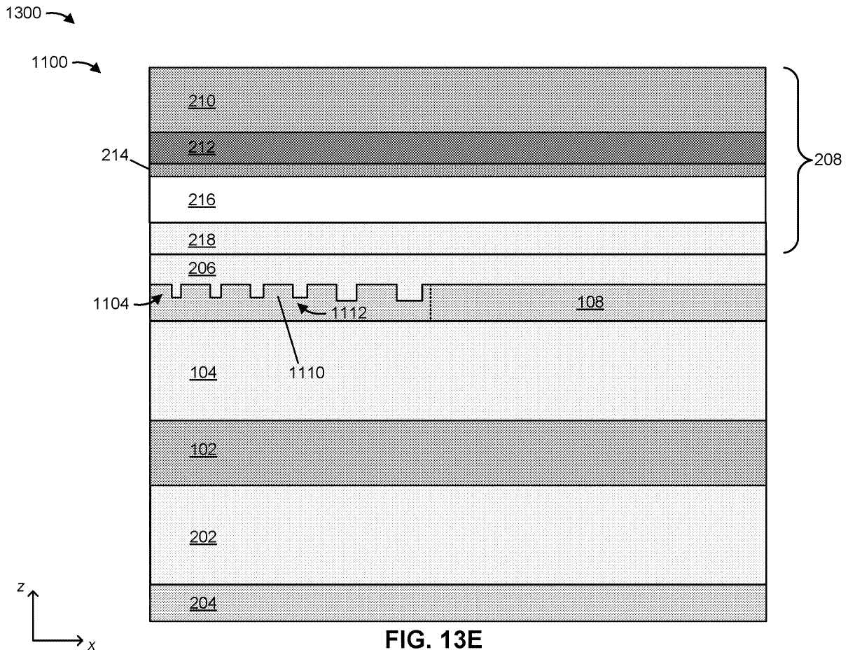

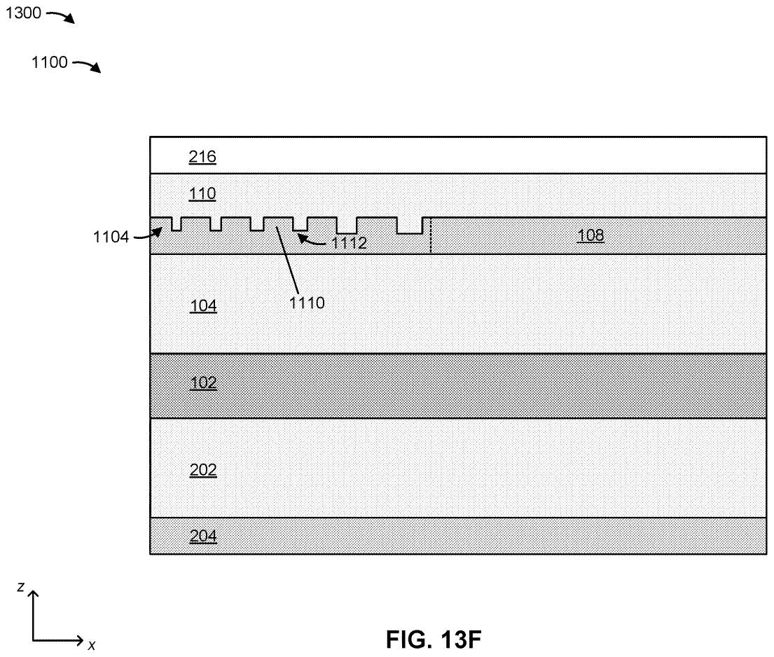

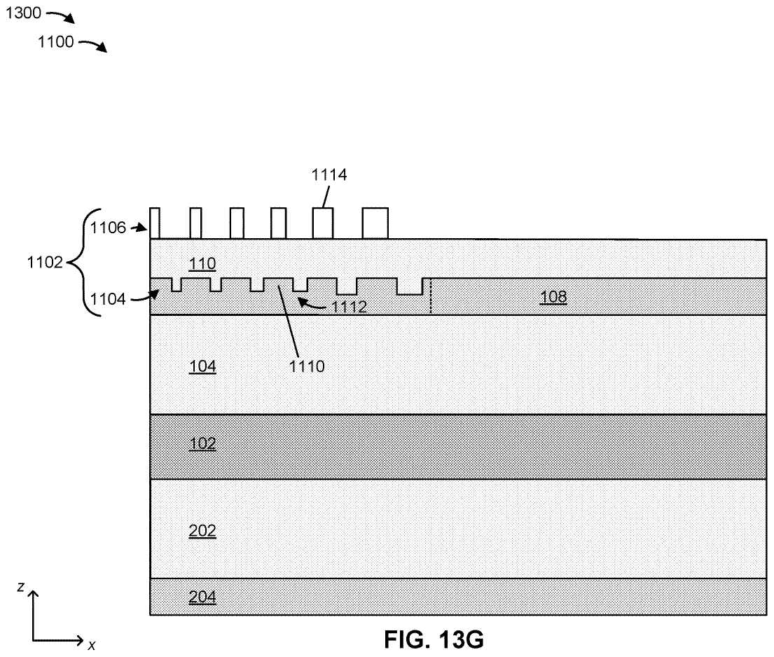

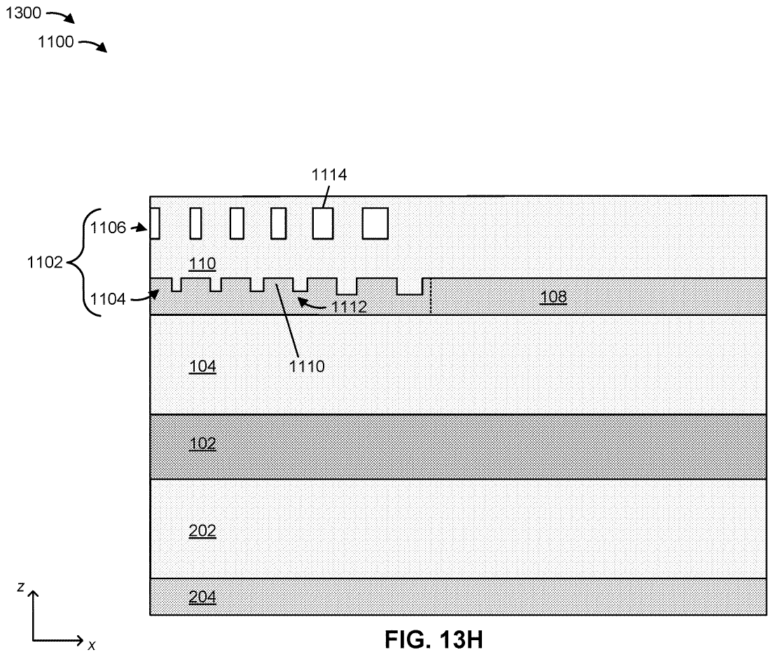

FIGS. 13A-13H are diagrams of an example implementation 1300 of forming the semiconductor photonics device 1100 described herein. In particular, the example implementation 1300 includes an example of forming the dielectric waveguide structure 108 and the dielectric portion 1104 of the hybrid grating coupler structure 1102 of the semiconductor photonics device 1100 prior to formation of the semiconductor photonics components of the semiconductor photonics device 1100 such as the semiconductor portion 1106 of the hybrid grating coupler structure 1102. The semiconductor photonics components such as the semiconductor portion 1106 of the hybrid grating coupler structure 1102 are formed above the dielectric waveguide structure 108 in the semiconductor photonics device 100. The example implementation 1300 includes an example of patterning the dielectric layer 106 and forming the dielectric waveguide structure 108 and the dielectric portion 1104 of the hybrid grating coupler structure 1102 from the dielectric layer 106 prior to forming or providing a top semiconductor layer from which the semiconductor photonics components such as the semiconductor portion 1106 of the hybrid grating coupler structure 1102 are formed.

In some implementations, one or more operations described in connection with FIGS. 13A-13H are performed using a semiconductor processing tool, such as a deposition tool, an exposure tool, a developer tool, an etch tool, a planarization tool, a bonding tool, and/or an annealing tool, among other examples. In some implementations, one or more operations described in connection with FIGS. 13A-13H may be performed to form another semiconductor photonics device described herein, such as the semiconductor photonics device 100 illustrated and described in connection with FIGS. 1A-1E, the semiconductor photonics device 400 illustrated and described in connection with FIGS. 4A-4C, the semiconductor photonics device 500 illustrated and described in connection with FIGS. 5A and 5B, the semiconductor photonics device 600 illustrated and described in connection with FIGS. 6A-6C, the semiconductor photonics device 700 illustrated and described in connection with FIGS. 7A and 7B, the semiconductor photonics device 800 illustrated and described in connection with FIG. 8, the semiconductor photonics device 900 illustrated and described in connection with FIGS. 9A and 9B, and/or the semiconductor photonics device 1000 illustrated and described in connection with FIGS. 10A and 10B, among other examples.

As shown in FIG. 13A, similar processing operations as described in connection with FIGS. 2A-2D may be performed to form the dielectric layers 104, 106, and 206 on the semiconductor substrate 102. As further shown in FIG. 13A, a masking layer 1302 is formed on the dielectric layer 206. In some implementations, the masking layer 1302 includes a photoresist layer, and a deposition tool is used to form the masking layer 1302 using a spin-coating technique. In some implementations, the masking layer 1302 includes a hard mask layer, and a deposition tool is used to form the masking layer 1302 using a PVD technique, a CVD technique, an ALD technique, and/or another suitable deposition technique.

As shown in FIG. 13B, a pattern 1304 may be formed in the masking layer 1302. The pattern 1304 may be formed for use in etching the dielectric layer 106 to remove portions of the dielectric layer 106 to form the dielectric waveguide structure 108 and the dielectric portion 1104 of the hybrid grating coupler structure 1102 in the dielectric layer 106 prior to providing or attaching the semiconductor layer 216 to the semiconductor photonics device 100. Alternatively, the pattern 1304 may be formed for use in etching the dielectric layer 106 to remove portions of the dielectric layer 106 to form the dielectric portion 1104 of the hybrid grating coupler structure 1102 in the dielectric layer 106 prior to providing or attaching the semiconductor layer 216 to the semiconductor photonics device 100, and the dielectric layer 106 is subsequently etched after providing or attaching the semiconductor layer 216 to form the dielectric waveguide structure 108.

In implementations in which the masking layer 1302 is a photoresist layer, the pattern 1304 may be formed in the masking layer 1302 by using an exposure tool to expose the masking layer 1302 to a radiation source and using a developer tool to develop and remove portions of the masking layer 1302 to expose the pattern 1304.

In implementations in which the masking layer 1302 is a hard mask layer, the pattern 1304 may be first formed in a photoresist layer and then transferred to the masking layer 1302 by etching. A deposition tool may be used to form the photoresist layer on the masking layer 1302. An exposure tool may be used to expose the photoresist layer to a radiation source to pattern the photoresist layer. A developer tool may be used to develop and remove portions of the photoresist layer to expose the pattern 1304. An etch tool may be used to etch the masking layer 1302 based on the pattern 1304 in the photoresist layer to transfer the pattern 1304 to the masking layer 1302. In some implementations, a photoresist removal tool may be used to remove the remaining portions of the photoresist layer (e.g., using a chemical stripper, plasma ashing, and/or another technique).

As shown in FIG. 13C, the pattern 1304 in the masking layer 1302 is used to etch the dielectric layers 106 and 110 to define the dielectric waveguide structure 108. Moreover, the pattern 1304 in the masking layer 1302 is used to etch the dielectric layers 106 and 110 to define the dielectric portion 1104 of the hybrid grating coupler structure 1102. In this way, the dielectric waveguide structure 108 and the dielectric portion 1104 of the hybrid grating coupler structure 1102 are formed prior to the semiconductor layer 216 being provided on the semiconductor photonics device 100.

As shown in FIG. 13D, additional material of the dielectric layer 206 may be deposited to backfill the areas of the dielectric layers 106 and 206 that were removed in forming the dielectric portion 1104 of the hybrid grating coupler structure 1102. The additional material of the dielectric layer 206 may fill in the recesses 1112 between the gratings 1110 of the dielectric portion 1104 of the hybrid grating coupler structure 1102. In some implementations, a planarization tool is used to perform a CMP operation to planarize the dielectric layer 206 after the additional material of the dielectric layer 206 is deposited.

As shown in FIG. 13E, the wafer stack 208, including the semiconductor layer 216, is bonded to the semiconductor photonics device 100 after the dielectric layers 106 and 206 are etched to form the dielectric waveguide structure 108 and the dielectric portion 1104 of the hybrid grating coupler structure 1102. The wafer stack 208 may be bonded to the semiconductor photonics device 100 in a similar manner as described in connection with FIG. 2E.

As shown in FIG. 13F, the carrier wafer 210 and the etch stop layers 212 and 214 may be removed from the semiconductor photonics device 100 after bonding the wafer stack 208 to the semiconductor photonics device 100. The carrier wafer 210 and the etch stop layers 212 and 214 may be removed using one or more techniques described in connection with FIGS. 2F and 2G. A planarization tool may be used to planarize the semiconductor layer 216 after the carrier wafer 210 and the etch stop layers 212 and 214 are removed.

As shown in FIG. 13G, the semiconductor layer 216 is etched to define the gratings 1114 of the semiconductor portion 1106 of the hybrid grating coupler structure 1102. In some implementations, a pattern in a photoresist layer is used to etch the semiconductor layer 216 to define the gratings 1114 of the semiconductor portion 1106 of the hybrid grating coupler structure 1102. In these implementations, a deposition tool may be used to form the photoresist layer on the semiconductor layer 216. An exposure tool may be used to expose the photoresist layer to a radiation source to pattern the photoresist layer. A developer tool may be used to develop and remove portions of the photoresist layer to expose the pattern. An etch tool may be used to etch the semiconductor layer 216 based on the pattern to form the gratings 1114. In some implementations, the etch operation includes a dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique).

As shown in FIG. 13H, additional material of the dielectric layer 110 may be deposited to backfill the areas of the semiconductor layer 216 that were removed such that the semiconductor portion 1106 of the hybrid grating coupler structure 1102 is encapsulated in the dielectric layer 110. In some implementations, a planarization tool is used to perform a CMP operation to planarize the dielectric layer 110 after the additional material of the dielectric layer 110 is deposited.

As indicated above, FIGS. 13A-13H are provided as an example. Other examples may differ from what is described with regard to FIGS. 13A-13H.

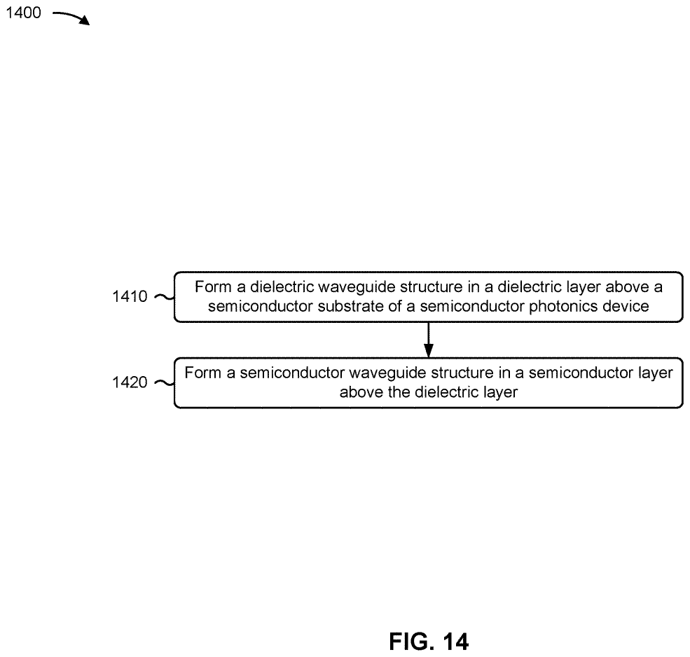

FIG. 14 is a flowchart of an example process 1400 associated with forming a semiconductor photonics device described herein. In some implementations, one or more process blocks of FIG. 14 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 14, process 1400 may include forming a dielectric waveguide structure in a dielectric layer above a semiconductor substrate of a semiconductor photonics device (block 1410). For example, one or more semiconductor processing tools may be used to form a dielectric waveguide structure (e.g., a dielectric waveguide structure 108) in a dielectric layer (e.g., a dielectric layer 106) above a semiconductor substrate (e.g., a semiconductor substrate 102) of a semiconductor photonics device (e.g., a semiconductor photonics device 100, 400, 600, 700, 800, 900, 1000, and/or 1100), as described herein.

As further shown in FIG. 14, process 1400 may include forming a semiconductor waveguide structure in a semiconductor layer above the dielectric layer (block 1420). For example, one or more semiconductor processing tools may be used to form a semiconductor waveguide structure (e.g., a semiconductor waveguide structure 112) in a semiconductor layer (e.g., a semiconductor layer 216) above the dielectric layer, as described herein.

Process 1400 may include additional implementations, such as any single implementation or any combination of implementations described below and/or in connection with one or more other processes described elsewhere herein.

In a first implementation, process 1400 includes forming, using an LPCVD technique, the dielectric layer on an oxide layer (e.g., a dielectric layer 104) above the semiconductor substrate.

In a second implementation, alone or in combination with the first implementation, process 1400 includes depositing, using a PECVD technique, the dielectric layer on an oxide layer (e.g., a dielectric layer 104) above the semiconductor substrate, and performing an annealing operation on the dielectric layer after depositing the dielectric layer.

In a third implementation, alone or in combination with one or more of the first and second implementations, performing the annealing operation includes performing an RTA operation at a temperature greater than or approximately equal to 800 degrees Celsius.

In a fourth implementation, alone or in combination with one or more of the first through third implementations, performing the annealing operation includes performing a furnace annealing operation at a temperature greater than or approximately equal to 1150 degrees Celsius.

In a fifth implementation, alone or in combination with one or more of the first through fourth implementations, the dielectric layer (e.g., the dielectric layer 106) includes a silicon nitride (SiₓN_{y}) layer, and a concentration of silicon-hydrogen (Si-H) bonds in the silicon nitride layer after the annealing operation is less than a concentration of silicon-hydrogen bonds in the silicon nitride layer prior to the annealing operation.

In a sixth implementation, alone or in combination with one or more of the first through fifth implementations, the dielectric layer (e.g., the dielectric layer 106) includes a silicon nitride (SiₓN_{y}) layer, and a concentration of nitrogen-hydrogen (N-H) bonds in the silicon nitride layer after the annealing operation is less than a concentration of nitrogen-hydrogen bonds in the silicon nitride layer prior to the annealing operation.

Although FIG. 14 shows example blocks of process 1400, in some implementations, process 1400 includes additional blocks, fewer blocks, different blocks, or differently arranged blocks than those depicted in FIG. 14. Additionally, or alternatively, two or more of the blocks of process 1400 may be performed in parallel.

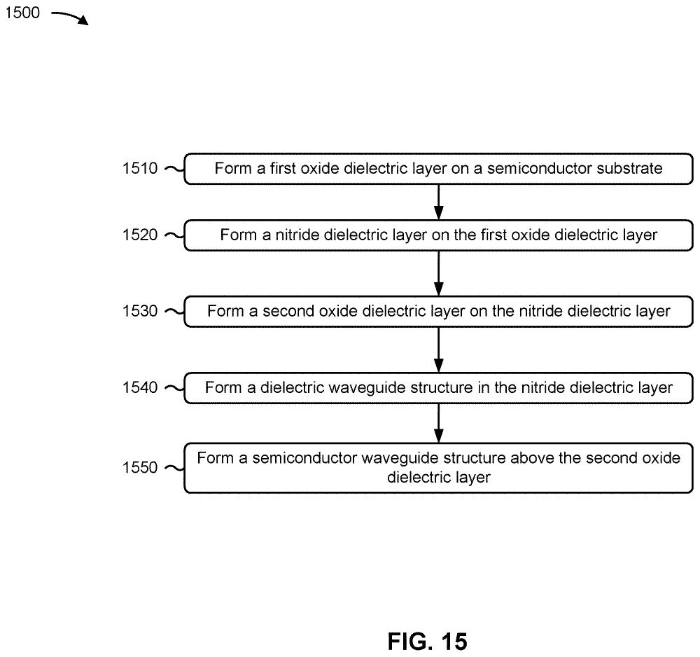

FIG. 15 is a flowchart of an example process 1500 associated with forming a semiconductor photonics device described herein. In some implementations, one or more process blocks of FIG. 15 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 15, process 1500 may include forming a first oxide dielectric layer on a semiconductor substrate (block 1510). For example, one or more semiconductor processing tools may be used to form a first oxide dielectric layer (e.g., a dielectric layer 104) on a semiconductor substrate (e.g., a semiconductor substrate 102), as described herein.

As further shown in FIG. 15, process 1500 may include forming a nitride dielectric layer on the first oxide dielectric layer (block 1520). For example, one or more semiconductor processing tools may be used to form a nitride dielectric layer (e.g., a dielectric layer 106) on the first oxide dielectric layer, as described herein.

As further shown in FIG. 15, process 1500 may include forming a second oxide dielectric layer on the nitride dielectric layer (block 1530). For example, one or more semiconductor processing tools may be used to form a second oxide dielectric layer (e.g., a dielectric layer 110) on the nitride dielectric layer, as described herein.

As further shown in FIG. 15, process 1500 may include forming a dielectric waveguide structure in the nitride dielectric layer after forming the second oxide dielectric layer (block 1540). For example, one or more semiconductor processing tools may be used to form a dielectric waveguide structure (e.g., a dielectric waveguide structure 108) in the nitride dielectric layer after forming the second oxide dielectric layer, as described herein.

As further shown in FIG. 15, process 1500 may include forming a semiconductor waveguide structure above the second oxide dielectric layer (block 1550). For example, one or more semiconductor processing tools may be used to form a semiconductor waveguide structure (e.g., a semiconductor waveguide structure 112) above the second oxide dielectric layer, as described herein.

Process 1500 may include additional implementations, such as any single implementation or any combination of implementations described below and/or in connection with one or more other processes described elsewhere herein.

In a first implementation, process 1500 includes bonding a monocrystalline semiconductor layer (e.g., a semiconductor layer 216) to the second oxide dielectric layer, where forming the semiconductor waveguide structure includes forming the semiconductor waveguide structure in the monocrystalline semiconductor layer.

In a second implementation, alone or in combination with the first implementation, forming the dielectric waveguide structure includes forming the dielectric waveguide structure after bonding the monocrystalline semiconductor layer to the second oxide dielectric layer.

In a third implementation, alone or in combination with one or more of the first and second implementations, forming the dielectric waveguide structure includes etching through the monocrystalline semiconductor layer and through the second oxide dielectric layer to remove portions of the nitride dielectric layer to form the dielectric waveguide structure.

In a fourth implementation, alone or in combination with one or more of the first through third implementations, forming the dielectric waveguide structure includes forming the dielectric waveguide structure prior to bonding the monocrystalline semiconductor layer to the second oxide dielectric layer.

In a fifth implementation, alone or in combination with one or more of the first through fourth implementations, forming the dielectric waveguide structure includes etching the nitride dielectric layer to remove portions of the nitride dielectric layer to form the dielectric waveguide structure, and process 1500 includes depositing additional material of the second oxide dielectric layer in areas of the removed portions of the nitride dielectric layer and planarizing the second oxide dielectric layer after depositing additional material of the second oxide dielectric layer.

In a sixth implementation, alone or in combination with one or more of the first through fifth implementations, process 1500 includes forming, in the nitride dielectric layer, a dielectric portion (e.g., a dielectric portion 1104) of a hybrid grating coupler structure (e.g., a hybrid grating coupler structure 1102), and forming, in a semiconductor layer (e.g., the semiconductor layer 216) above the second oxide dielectric layer, a semiconductor portion (e.g., a semiconductor portion 1106) of the hybrid grating coupler structure.

Although FIG. 15 shows example blocks of process 1500, in some implementations, process 1500 includes additional blocks, fewer blocks, different blocks, or differently arranged blocks than those depicted in FIG. 15. Additionally, or alternatively, two or more of the blocks of process 1500 may be performed in parallel.

In this way, a dielectric waveguide structure of a semiconductor photonics device is formed prior to formation of the semiconductor photonics components of the semiconductor photonics device. This enables high-temperature processing techniques to be used to form the dielectric waveguide structure without concern for potential damage that might otherwise be caused to the semiconductor photonics components if the dielectric waveguide were to be formed above the semiconductor photonics components. The use of the high-temperature processing techniques may enable low optical loss to be achieved for the dielectric waveguide structure in that the high-temperature processing techniques may be used to achieve a low hydrogen concentration in the dielectric waveguide structure. The low hydrogen concentration in the dielectric waveguide structure enables higher performance to be achieved for the dielectric waveguide structure, including greater operating efficiency and increased communication bandwidth.

As described in greater detail above, some implementations described herein provide a method. The method includes forming a dielectric waveguide structure in a dielectric layer above a semiconductor substrate of a semiconductor photonics device. The method includes forming a semiconductor waveguide structure in a semiconductor layer above the dielectric layer.

As described in greater detail above, some implementations described herein provide a method. The method includes forming a first oxide dielectric layer on a semiconductor substrate. The method includes forming a nitride dielectric layer on the first oxide dielectric layer. The method includes forming a second oxide dielectric layer on the nitride dielectric layer. The method includes forming a dielectric waveguide structure in the nitride dielectric layer after forming the second oxide dielectric layer. The method includes forming a semiconductor waveguide structure above the second oxide dielectric layer.

As described in greater detail above, some implementations described herein provide a semiconductor photonics device. The semiconductor photonics device includes a semiconductor layer. The semiconductor photonics device includes a first dielectric layer above the semiconductor layer. The semiconductor photonics device includes a second dielectric layer above the first dielectric layer. The semiconductor photonics device includes a first waveguide structure in the second dielectric layer. The semiconductor photonics device includes a third dielectric layer above the second dielectric layer. The semiconductor photonics device includes a second waveguide structure in the third dielectric layer, where the second dielectric layer comprises a different dielectric material than the first dielectric layer and the third dielectric layer.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a semiconductor layer;
a first dielectric layer above the semiconductor layer;
a second dielectric layer above the first dielectric layer;
a first waveguide structure in the second dielectric layer;
a third dielectric layer above the second dielectric layer; and
a second waveguide structure in the third dielectric layer,
wherein the second dielectric layer comprises a different dielectric material than the first dielectric layer and the third dielectric layer.

2. The semiconductor photonics device of claim 1, wherein the second waveguide structure comprises:
a strip waveguide section; and
a tapered waveguide section laterally adjacent to the strip waveguide section,
wherein the tapered waveguide section is located over the first waveguide structure.

3. The semiconductor photonics device of claim 2, wherein the tapered waveguide section is at least one of:
laterally tapered, or
vertically tapered.

4. The semiconductor photonics device of claim 1, wherein the second waveguide structure comprises:
a strip waveguide section; and
a transition section laterally adjacent to the strip waveguide section,
wherein the transition section comprises a plurality of steps, and
wherein the transition section is located over the first waveguide structure.

5. The semiconductor photonics device of claim 4, wherein the transition section is laterally tapered.

6. The semiconductor photonics device of claim 1, further comprising:
a dielectric portion of a hybrid grating coupler structure in the second dielectric layer; and
a semiconductor portion of the hybrid grating coupler structure above the dielectric portion of the hybrid grating coupler structure.

7. A semiconductor photonics device, comprising:
a semiconductor substrate;
an oxide layer above the semiconductor substrate;
a nitride layer above the oxide layer;
a dielectric waveguide structure in the nitride layer;
a cladding dielectric layer above the nitride layer; and
a semiconductor waveguide structure in the cladding dielectric layer and above the dielectric waveguide structure,
wherein the dielectric waveguide structure is optically coupled to the semiconductor waveguide structure.

8. The semiconductor photonics device of claim 7, wherein the nitride layer has a refractive index that is greater than a refractive index of the oxide layer and greater than a refractive index of the cladding dielectric layer.

9. The semiconductor photonics device of claim 7, wherein the semiconductor waveguide structure is at least partially laterally offset from the dielectric waveguide structure.

10. The semiconductor photonics device of claim 7, wherein the semiconductor waveguide structure is spaced apart from the nitride layer and the dielectric waveguide structure by the cladding dielectric layer.

11. The semiconductor photonics device of claim 7, wherein an end of the semiconductor waveguide structure facing the dielectric waveguide structure is located above a transition between the nitride layer and the dielectric waveguide structure.

12. The semiconductor photonics device of claim 7, wherein the dielectric waveguide structure is an edge coupler waveguide that has an end facing an edge of the semiconductor photonics device.

13. The semiconductor photonics device of claim 7, wherein a portion of the cladding dielectric layer between the nitride layer and the semiconductor waveguide structure has a thickness included in a range of approximately 150 nanometers to approximately 300 nanometers.

14. A semiconductor photonics device, comprising:
a semiconductor substrate;
a first oxide dielectric layer above the semiconductor substrate;
a nitride dielectric layer above the first oxide dielectric layer;
a dielectric waveguide structure in the nitride dielectric layer;
a second oxide dielectric layer above the nitride dielectric layer;
a semiconductor waveguide structure in the second oxide dielectric layer and above the dielectric waveguide structure; and
an optical structure in the second oxide dielectric layer and above the nitride dielectric layer,
wherein the optical structure is optically coupled to the semiconductor waveguide structure.

15. The semiconductor photonics device of claim 14, wherein the optical structure comprises an optical modulator structure located laterally adjacent to the semiconductor waveguide structure.

16. The semiconductor photonics device of claim 15, wherein the optical modulator structure comprises a P-N junction that includes a p-doped contact and an n-doped contact.

17. The semiconductor photonics device of claim 16, wherein the p-doped contact and the n-doped contact are coupled to respective interconnect structures in the second oxide dielectric layer.

18. The semiconductor photonics device of claim 14, wherein the optical structure further comprises a grating coupler.

19. The semiconductor photonics device of claim 14, wherein the optical structure comprises a photodetector structure.

20. The semiconductor photonics device of claim 14, further comprising an interconnect layer above the second oxide dielectric layer, wherein the interconnect layer comprises one or more metallization layers coupled to the optical structure.
